(19) United States
(12) Patent Application Publication
(10) Pub. No.: US 2009/0319246 A1
(43) Pub. Date: Dec. 24, 2009

(54) DETECTION PROGRAM, DETECTING DEVICE, AND DETECTING METHOD

(75) Inventor: Koichiro Takayama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/408,687

(22) Filed: Mar. 21, 2009

(30) Foreign Application Priority Data
Jun. 18, 2008 (JP) 2008159512

(51) Int. Cl. G06F 17/50

(52) U.S. Cl. 703/13

(57) ABSTRACT

A computer-readable recording medium stores a detection program. The detection program causes a computer to execute performing the scenario model and assigning a predetermined test value to the input variable of the scenario model; performing the implementation model and assigning the test value to the input variable of the implementation model; analyzing a structure of read and write processes for each input variable of the scenario model; analyzing a structure of read and write processes for each input variable of the implementation model; comparing a value of the output variable associated with performing the scenario model and a value of the output variable associated with performing the implementation model; and comparing the structure related to the scenario model and that related to the implementation model to detect a difference between the two models.

### CROSS-REFERENCE TO RELATED APPLICATION

This application is based upon and claims the benefit of priority of the prior Japanese Patent Application No. 2008-159512, filed on Jun. 18, 2008, the entire contents of which are incorporated herein by reference.

### FIELD

The embodiments discussed herein are directed to a detection program, detecting device, and detecting method.

### BACKGROUND

Conventionally, implementation of hardware and software is performed according to a scenario defined at a designing stage. In the scenario, contents required as functions incorporated in hardware or software are defined in a natural language. Implementation is performed by describing the scenario defined in the natural language into an artificial language.

For example, as a technique of implementing a synchronous digital circuit into a Large Scale Integration (LSI), there is an abstract level called Register Transfer Level (RTL). At this level, the scenario of the synchronous digital circuit is first described in a Hardware Description Language (HDL), such as Verilog, as an implementation model. This implementation model is then converted by a logic synthesizing tool to generate an actual circuit.

Meanwhile, in implementation of hardware and software, for the purpose of verifying whether the scenario and the implementation match each other, various techniques have been attempted. For example, there is a technique of performing a simulation with a scenario model and an implementation model. Like the implementation model, the scenario model is such that a scenario defined in a natural language is described into an artificial language, which is a general-purpose programming language, such as the C. That is, the scenario model is described in order to achieve functions according to the scenario. In this technique, a developer compares the simulation result obtained from the scenario model and the simulation result obtained from the implementation model with each other, and main signals are manually traced when these results are different, thereby detecting a fault in the implementation model.

Also, for example, there is another technique of comparing a signal database generated by extracting a signal group from the description of the scenario of the LSI and a signal database generated by extracting a signal group from the description in a hardware description language. In addition, there is still another technique of generating data for verification from a time sequence diagram defined in the scenario and still another technique of displaying the execution order of software by using a message sequence.

Examples of these techniques are disclosed in Japanese Laid-open Patent Publication No. 2007-94891, Japanese Laid-open Patent Publication No. 2007-52634, and Japanese Laid-open Patent Publication No. 10-31597.

However, the conventional techniques have a problem in which a fault in the implementation model cannot be efficiently and appropriately detected. That is, in the technique of performing a simulation, the developer has to manually trace main signals, and therefore a fault in the implementation model cannot be efficiently detected. Moreover, in the technique of comparing the signal databases, the signal databases generated from the descriptions are merely compared with each other, and therefore a fault in the implementation model cannot be appropriately detected. Furthermore, neither the technique of generating data for verification nor the technique of displaying the execution order can achieve an efficient and appropriate detection of a fault in the implementation model.

### SUMMARY

According to an aspect of the invention, a computer-readable recording medium stores therein a detection program. The detection program causes a computer to execute: when a scenario, in which the relation between a process performed according to an input variable and a value assigned to the input variable and an output variable to which a value of the result of the process is assigned is defined in a natural language, is described in a predetermined artificial language and is stored as a scenario model in a scenario-model storage unit, executing the scenario model by reading the scenario model from the scenario-model storage unit and substituting a predetermined test value into the input variable of the scenario model; when the scenario is described in an artificial language for implementation and is stored as an implementation model in an implementation-model storage unit, executing the implementation model by reading the implementation model from the implementation-model storage unit and substituting the test value into the input variable of the implementation model; analyzing a structure of a read process and a write process for each input variable of the scenario model by the executing of the scenario model, from a time when the test value is assigned to an input variable to a time when the resultant value is assigned to an output variable, to store the analyzed structure in a scenario-model analysis-result storage unit; analyzing a structure of a read process and a write process for each input variable of the implementation model by the executing of the implementation model, from a time when the test value is assigned to an input variable to a time when the resultant value is assigned to an output variable, to store the analyzed structure in a implementation-model analysis-result storage unit; comparing a value of the output variable output through the executing of the scenario model and a value of the output variable output through the executing of the implementation model; and when the values of the output variables are different from each other as a result of the comparison, comparing the structure stored in the scenario-model analysis-result storage unit and the structure stored in the implementation-model analysis-result storage unit to detect a difference between the scenario model and the implementation model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a drawing for explaining a general outline of a detecting device according to a first embodiment;

FIG. 2 is a block diagram of the configuration of the detecting device according to the first embodiment;

FIG. 3 is a drawing for explaining a scenario;

FIG. 4 is a drawing for explaining a scenario model;

FIG. 5 is a drawing for explaining an implementation model;

FIG. 6 is a drawing for explaining test patterns;

FIG. 7 is a drawing for explaining a CDFG of the scenario model;

FIG. 8 is a drawing for explaining generation of a CDFG by parsing;

FIG. 9 is a drawing for explaining generation of a CDFG by parsing;

FIG. 10 is a drawing for explaining generation of a reference graph of the scenario model;

FIG. 11 is a drawing for explaining processing of the scenario model;

FIG. 12 is a drawing for explaining collection of execution path information;

FIG. 13 is a drawing for explaining node extraction for the reference graph;

FIG. 14 is a drawing for explaining edge extraction for the reference graph;

FIG. 15 is a drawing for explaining extraction of an execution trace;

FIG. 16 is a drawing for explaining node extraction in the reference graph;

FIG. 17 is a drawing for explaining edge extraction in the reference graph;

FIG. 18 is a drawing for explaining the reference graph;

FIG. 19 is a drawing for explaining dependency;

FIG. 20 is a drawing for explaining a CDFG of the implementation model;

FIG. 21 is a drawing for explaining generation of a reference graph of the implementation model;

FIG. 22 is a drawing for explaining analysis of the reference graph;

FIG. 23 is a drawing for explaining analysis of the reference graph;

FIG. 24 is a drawing for explaining a comparison algorithm for the reference graph;

FIG. 25 is a drawing for explaining an output screen of the detection result;

FIG. 26 is a flowchart of a process procedure by the detecting device according to the first embodiment;

FIG. 27 is a drawing for explaining an implementation model;

FIG. 28 is a drawing for explaining generation of a reference graph of the scenario model;

FIG. 29 is a drawing for explaining a CDFG of the implementation model;

FIG. 30 is a drawing for explaining generation of a reference graph of the implementation model;

FIG. 31 is a drawing for explaining analysis of the reference graph;

FIG. 32 is a drawing for explaining analysis of the reference graph; and

FIG. 33 is a drawing of a computer that executes a detection program.

### DESCRIPTION OF EMBODIMENTS

Preferred embodiments of the present invention will be explained with reference to accompanying drawings. In the following, a general outline of a detecting device according to a first embodiment is explained first, and the configuration and process procedure of the detecting device according to the first embodiment and effects of the first embodiment are explained. Subsequently, other embodiments are explained.

### First Embodiment

### General Outline of the Detecting Device According to the First Embodiment

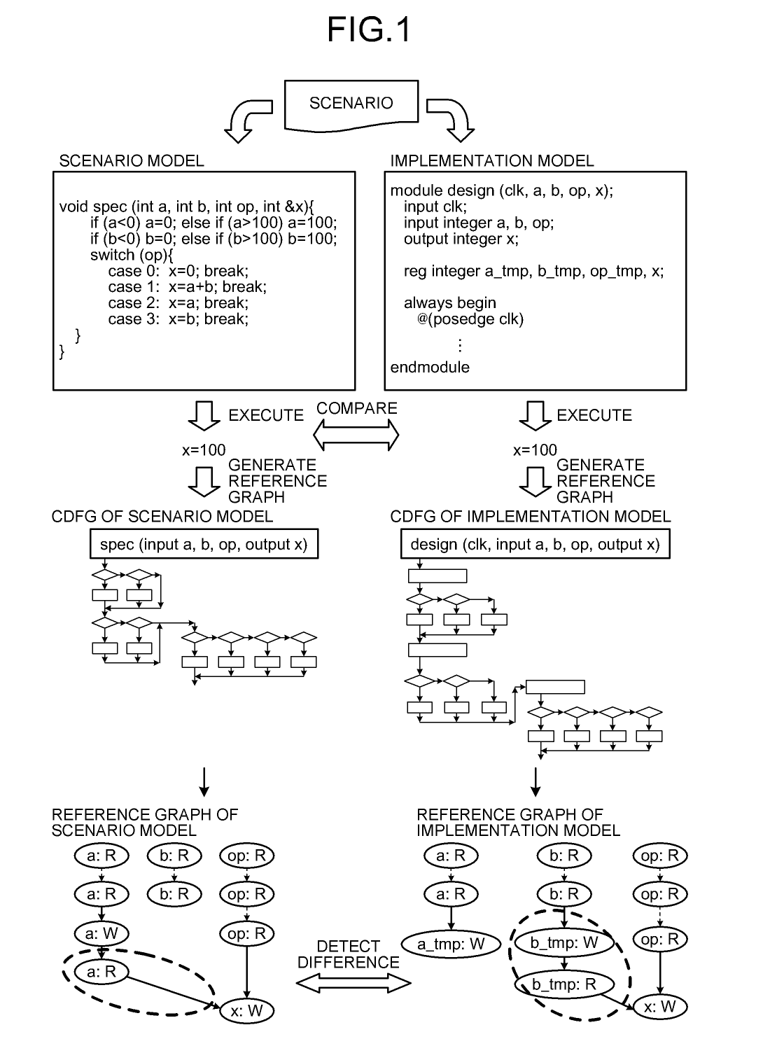

First, a general outline of the detecting device according to the first embodiment is explained by using FIG. 1. FIG. 1 is a drawing for explaining the general outline of the detecting device according to the first embodiment. In the first embodiment, implementation of hardware is assumed.

As depicted in FIG. 1, the detecting device according to the first embodiment has a scenario model and an implementation model stored therein, the scenario model in which a scenario defined in a natural language is described in the C language, and the implementation model described in Verilog. Although not illustrated in FIG. 1, the detecting device has also stored therein a test pattern as a value assigned to an input variable when the scenario model or implementation model is executed.

The detecting device according to the first embodiment executes the scenario model by assigning the test pattern to the input variable of the scenario model, and executes the implementation model by assigning the test pattern to the input variable of the implementation model. Also, as depicted in FIG. 1, the detecting device compares the execution result (a value of an output variable) output by executing the scenario model and the execution result output by executing the implementation model with each other.

Then, as depicted in FIG. 1, when the execution result of the scenario model and the execution result of the implementation model are different from each other as result of comparison, the detecting device according to the first embodiment generates a reference graph of the scenario model and a reference graph of the implementation model. Each reference graph indicates for each input variable, the structure of a reading process and a writing process from the time when the test pattern is assigned to the input variable to the time when the resultant value is assigned to the output variable. As will be explained further below, the detecting device parses the scenario model and the implementation model to generate a Control Data Flow Graph (CDFG), and then generates a reference graph from the CDFG.

Next, as depicted in FIG. 1, the detecting device according to the first embodiment compares the reference graph of the scenario graph and the reference graph of the implementation graph to detect a difference between the scenario model and the implementation model.

In this manner, when the scenario model and the implementation model are different from each other in the execution result with the test pattern, the detecting device according to the first embodiment compares the reference graph of the scenario model and the reference graph of the implementation model to detect a difference between these reference graphs. From this, the detecting device can efficiently and appropriately detect a fault in the implementation model.

### Configuration of the Detecting Device According to the First Embodiment

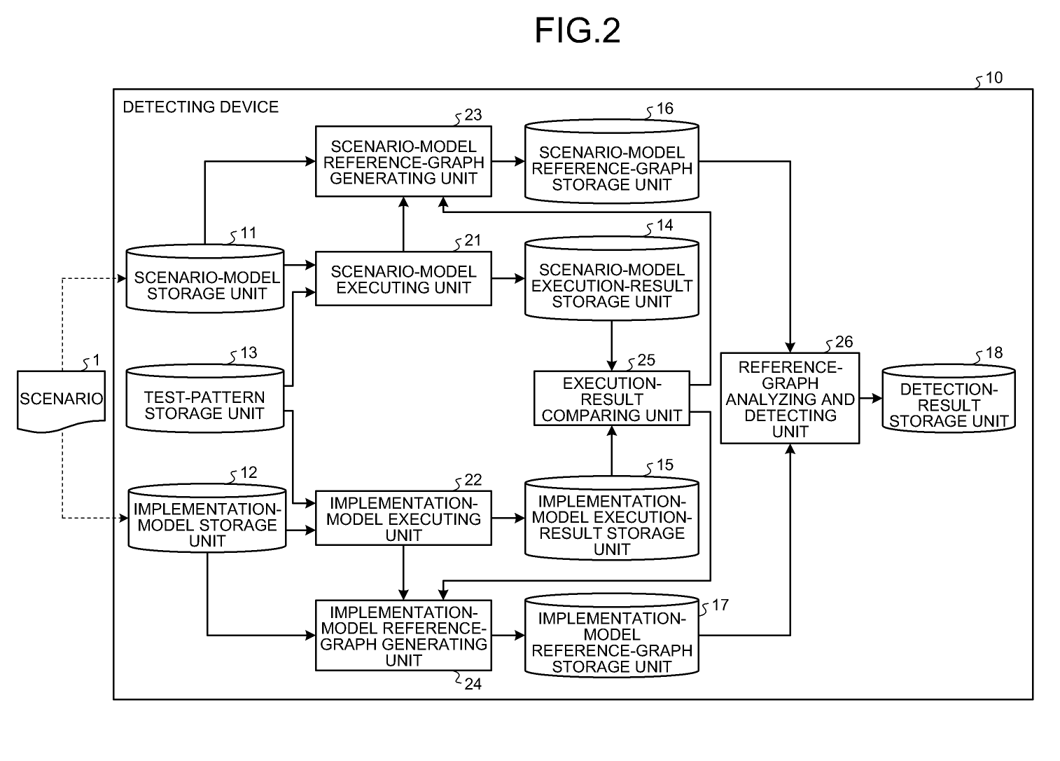

Next, the configuration of the detecting device according to the first embodiment is explained by using FIG. 2. FIG. 2 is a block diagram of the configuration of the detecting device according to the first embodiment.

As depicted in FIG. 2, a detecting device 10 according to the first embodiment particularly includes, as storage units, a scenario-model storage unit 11, an implementation-model storage unit 12, a test-pattern storage unit 13, a scenario-model execution-result storage unit 14, an implementation-model execution-result storage unit 15, a scenario-model reference-graph storage unit 16, an implementation-model reference-graph storage unit 17, and a detection-result storage unit 18.

Also, as depicted in FIG. 2, the detecting device 10 according to the first embodiment particularly includes, as controlling units, a scenario-model executing unit 21, an implementation-model executing unit 22, a scenario-model reference-graph generating unit 23, an implementation-model reference-graph generating unit 24, an execution-result comparing unit 25, and a reference-graph analyzing and detecting unit 26.

The scenario-model storage unit 11 has stored therein a scenario model. Specifically, the scenario-model storage unit 11 has stored therein a scenario model obtained by describing a scenario 1 defined in a natural language into a predetermined artificial language. Also, the scenario model stored in the scenario-model storage unit 11 is used in a process by the scenario-model executing unit 21 and the scenario-model reference-graph generating unit 23. It is assumed in the first embodiment that the scenario model is described in advance by a developer and is input in advance from an input unit (not illustrated) by the developer. Therefore, the scenario-model storage unit 11 has the scenario model stored therein in advance.

The implementation-model storage unit 12 has stored therein an implementation model. Specifically, the implementation-model storage unit 12 has stored therein an implementation model obtained by describing the scenario 1 defined in a natural language into an artificial language for implementation. Also, the implementation model stored in the implementation-model storage unit 12 is used in a process by the implementation-model executing unit 22 and the implementation-model reference-graph generating unit 24. It is assumed in the first embodiment that the implementation model is described in advance by a developer and is input in advance from an input unit (not illustrated) by the developer. Therefore, the implementation-model storage unit 12 has the implementation model stored therein in advance.

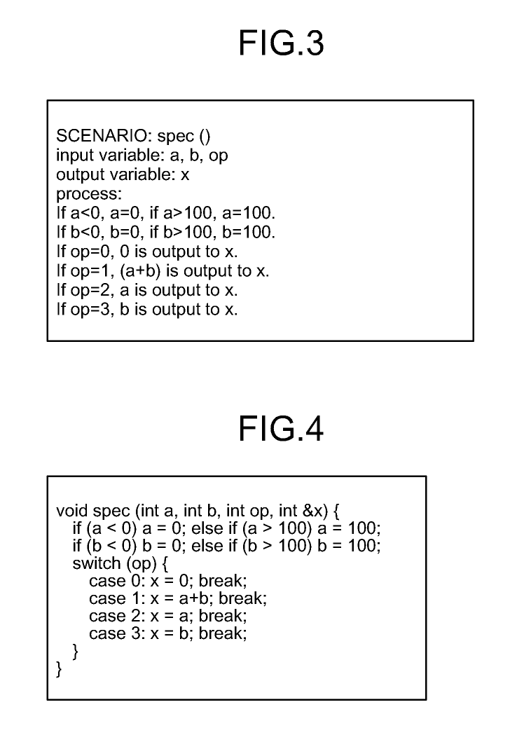

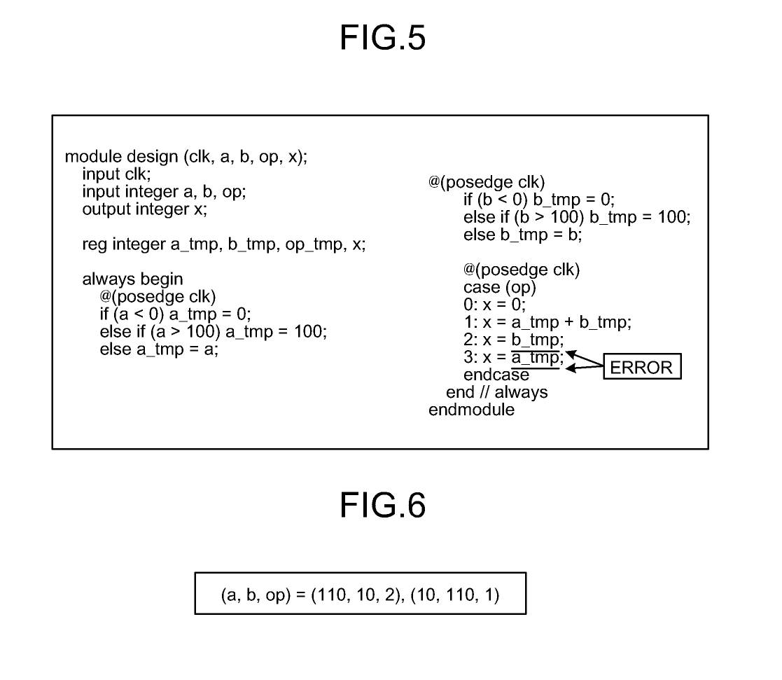

The scenario 1, the scenario model, and then the implementation model are exemplarily explained by using FIGS. 3 to 5. FIG. 3 is a drawing for explaining a scenario. FIG. 4 is a drawing for explaining a scenario model. FIG. 5 is a drawing for explaining an implementation model.

In the scenario 1 in the first embodiment, a relation among an input variable, a process to be performed according to values assigned to the input variable, and an output variable to which the value obtained as a result of the process is assigned is defined in a natural language. That is, as exemplarily depicted in FIG. 3, the scenario 1 defines in a natural language that the scenario 1 has a name of “spec( )”, input variables of “a, b, op”, and an output variable of “x”. Also, the scenario 1 defines in a natural language a process to be performed according to values assigned to the input variables of “a, b, op”.

Also, as exemplarily depicted in FIG. 4, the scenario model in the first embodiment has the scenario 1 exemplarily depicted in FIG. 3 described in the C language. Furthermore, as depicted in FIG. 5, the implementation model in the first embodiment has the scenario 1 exemplarily depicted in FIG. 3 described in Verilog. As evident from comparison between FIGS. 4 and 5, even if the models are described based on the same scenario 1, the scenario model described in the C language and the implementation model described in Verilog are different in description contents due to a difference in language. Also, since both of the scenario model and the implementation model are described by the developer, a fault may be included in the description contents, thereby causing a difference in description contents. In the first embodiment, as exemplarily depicted in FIG. 5, it is assumed that a fault is included in the description contents of the implementation model.

The test-pattern storage unit 13 has stored therein a test pattern. Specifically, the test-pattern storage unit 13 has a test pattern stored therein as a value assigned to the input variable when the scenario model or the implementation model is executed. Also, the test pattern stored in the test-pattern storage unit 13 is used in the process by the scenario-model executing unit 21 and the process by the implementation-model executing unit 22. In the first embodiment, it is assumed that the test pattern is set in advance by the developer and is input in advance from the input unit (not illustrated) by the developer. Therefore, the test-pattern storage unit 13 has the test pattern stored therein.

The test pattern is exemplarily explained by using FIG. 6. FIG. 6 is a drawing for explaining test patterns. As depicted in FIG. 6, there are two test patterns in the first embodiment, “(a, b, op)=(110, 10, 2)” and “(a, b, op)=(10, 110, 1)”.

The scenario-model execution-result storage unit 14 has stored therein the execution result of the scenario model. Specifically, the scenario-model execution-result storage unit 14 has stored therein the execution result (a value of the output variable) of the scenario model executed by the scenario-model executing unit 21. Also, the execution result stored in the scenario-model execution-result storage unit 14 is used in the process by the execution-result comparing unit 25. For example, the scenario-model execution-result storage unit 14 has “x=100” stored therein as the execution result of the scenario model.

The implementation-model execution-result storage unit 15 has stored therein the execution result of the implementation model. Specifically, the implementation-model execution-result storage unit 15 has stored therein the execution result (a value of the output variable) of the implementation model executed by the implementation-model executing unit 22. Also, the execution result stored in the implementation-model execution-result storage unit 15 is used in the process by the execution-result comparing unit 25. For example, the implementation-model execution-result storage unit 15 has “x=10” stored therein as the execution result of the implementation model.

The scenario-model reference-graph storage unit 16 has stored therein a reference graph of the scenario model. Specifically, the scenario-model reference-graph storage unit 16 has stored therein a reference graph generated by the scenario-model reference-graph generating unit 23. Also, the reference graph stored in the scenario-model reference-graph storage unit 16 is used in the process by the reference-graph analyzing and detecting unit 26. The reference graph will be explained in detail further below when the scenario-model reference-graph generating unit 23 and the implementation-model reference-graph generating unit 24 are explained.

The implementation-model reference-graph storage unit 17 has stored therein a reference graph of the implementation model. Specifically, the implementation-model reference-graph storage unit 17 has stored therein a reference graph generated by the implementation-model reference-graph generating unit 24. Also, the reference graph stored in the implementation-model reference-graph storage unit 17 is used in the process by the reference-graph analyzing and detecting unit 26.

The detection-result storage unit 18 has stored therein the detection result. Specifically, the detection-result storage unit 18 has stored therein the detection result detected by the reference-graph analyzing and detecting unit 26. Also, the detection result stored in the detection-result storage unit 18 is output from an output unit (not illustrated), such as a display. An output screen of the detection result will be explained in detail further below when the reference-graph analyzing and detecting unit 26 is explained.

The scenario-model executing unit 21 assigns the test pattern to the input variable of the scenario model to execute the scenario model. Specifically, the scenario-model executing unit 21 reads the scenario model from the scenario-model storage unit 11, and then assigns the test pattern stored in the test-pattern storage unit 13 to the input variable of the read scenario model, thereby executing the scenario model. The scenario-model executing unit 21 then stores the execution result in the scenario-model execution-result storage unit 14. For example, the scenario-model executing unit 21 assigns the test pattern (110, 10, 2) to the input variables (a, b, op) of the scenario model to execute the scenario model, and then stores the execution result “x=100” in the scenario-model execution-result storage unit 14.

The scenario-model executing unit 21 in the first embodiment does not merely execute the scenario model stored in the scenario-model storage unit 11, but processes the scenario model and executes the processed scenario model, thereby collecting execution path information when executing the scenario model. Also, the scenario-model executing unit 21 transmits the collected execution path information to the scenario-model reference-graph generating unit 23. As will be explained in detail below, the execution path information transmitted to the scenario-model reference-graph generating unit 23 is used when a reference graph is generated by the scenario-model reference-graph generating unit 23.

The implementation-model executing unit 22 assigns the test pattern to the input variable of the implementation model to execute the implementation model. Specifically, the implementation-model executing unit 22 reads the implementation model from the implementation-model storage unit 12, and then assigns the test pattern stored in the test-pattern storage unit 13 to the input variable of the read implementation model, thereby executing the implementation model. The implementation-model executing unit 22 then stores the execution result in the implementation-model execution-result storage unit 15. For example, the implementation-model executing unit 22 assigns the test pattern (110, 10, 2) to the input variables (a, b, op) of the implementation model to execute the implementation model, and then stores the execution result “x=10” in the implementation-model execution-result storage unit 15.

The implementation-model executing unit 22 in the first embodiment does not merely execute the implementation model stored in the implementation-model storage unit 12, but processes the implementation model and executes the processed implementation model, thereby collecting execution path information when executing the implementation model. Also, the implementation-model executing unit 22 transmits the collected execution path information to the implementation-model reference-graph generating unit 24. As will be explained in detail below, the execution path information transmitted to the implementation-model reference-graph generating unit 24 is used when a reference graph is generated by the implementation-model reference-graph generating unit 24.

The scenario-model reference-graph generating unit 23 analyzes, for each input variable of the scenario model, the structure of the read process and the write process from the time when the test pattern is assigned to the input variable to the time when the resultant value is assigned to the output variable to generate a reference graph of the scenario model. Specifically, when the comparison result transmitted from the execution-result comparing unit 25 indicates that the execution result of the scenario model and the execution result of the implementation model are different from each other, the scenario-model reference-graph generating unit 23 generates a reference graph of the scenario model. Also, the scenario-model reference-graph generating unit 23 generates a reference graph of the scenario model by using the scenario model stored in the scenario-model storage unit 11 and the execution path information transmitted from the scenario-model executing unit 21, and then stores the generated reference graph in the scenario-model reference-graph storage unit 16.

The implementation-model reference-graph generating unit 24 analyzes, for each input variable of the implementation model, the structure of the read process and the write process from the time when the test pattern is assigned to the input variable to the time when the resultant value is assigned to the output variable to generate a reference graph of the implementation model. Specifically, when the comparison result transmitted from the execution-result comparing unit 25 indicates that the execution result of the scenario model and the execution result of the implementation model are different from each other, the implementation-model reference-graph generating unit 24 generates a reference graph of the implementation model. Also, the implementation-model reference-graph generating unit 24 generates a reference graph of the implementation model by using the implementation model stored in the implementation-model storage unit 12 and the execution path information transmitted from the implementation-model executing unit 22, and then stores the generated reference graph in the implementation-model reference-graph storage unit 17.

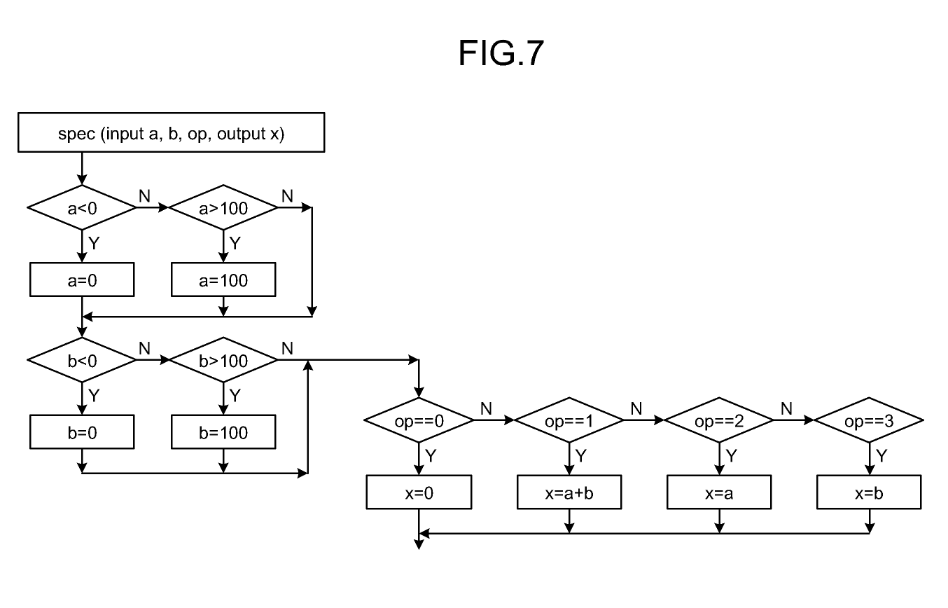

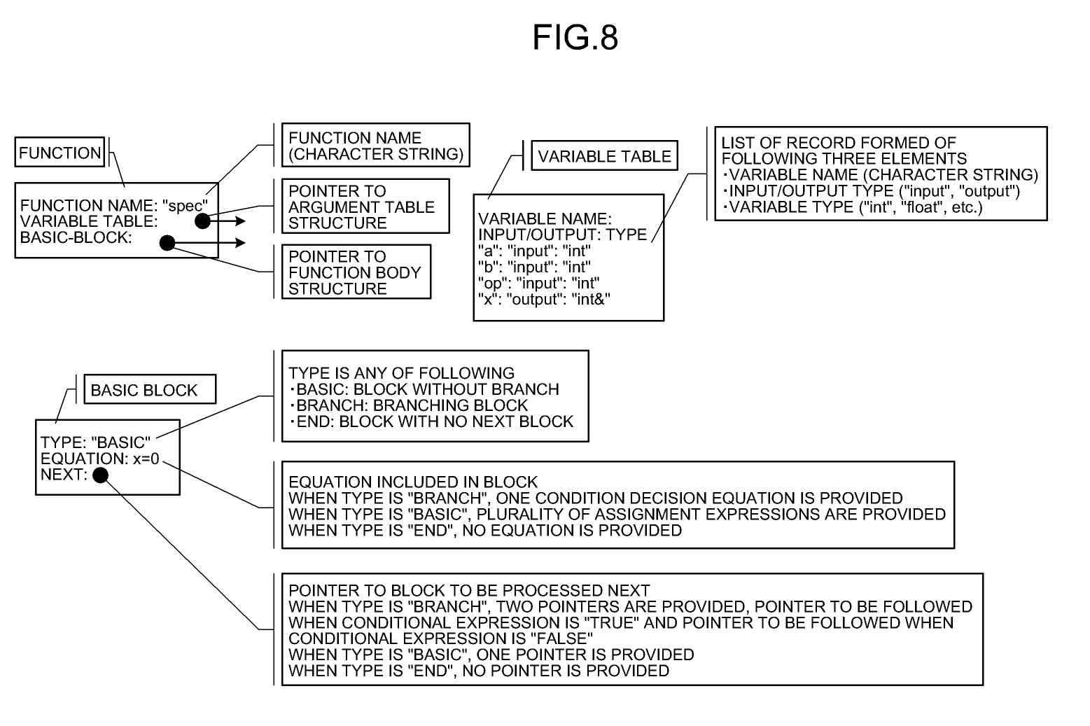

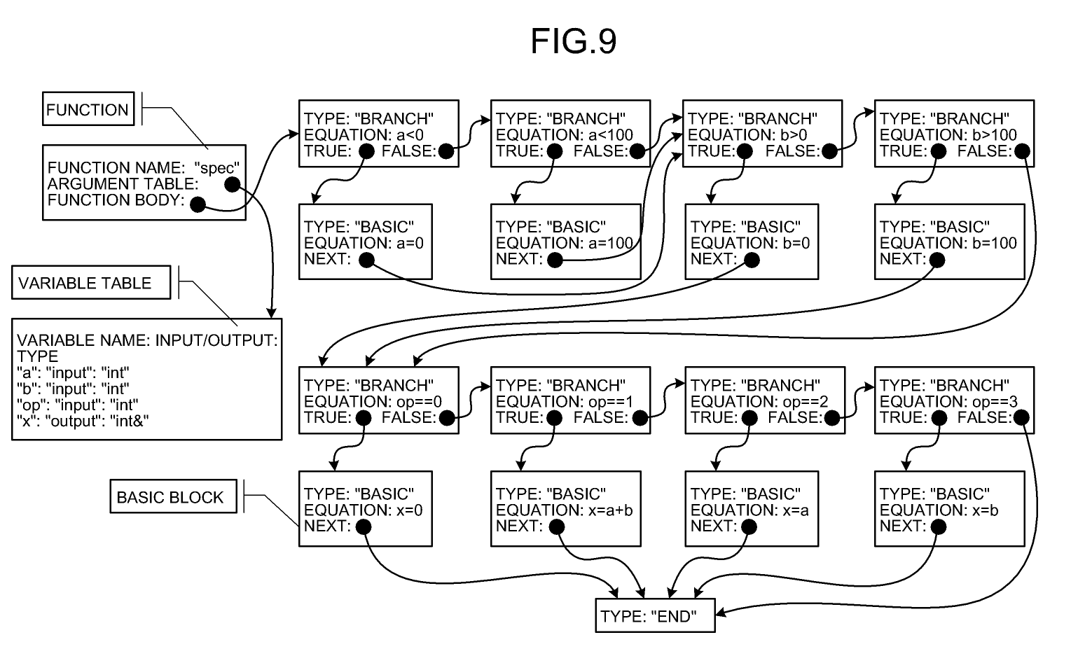

Generation of the reference graph of the scenario model and generation of the reference graph of the implementation model are explained by using FIGS. 7 to 21. First, by using FIGS. 7 to 9, generation of a CDFG from the scenario model is explained. FIG. 7 is a drawing for explaining a CDFG of the scenario model. FIGS. 8 and 9 are drawings for explaining generation of a CDFG by parsing.

When the comparison result transmitted from the execution-result comparing unit 25 indicates that the execution result of the implementation model and the execution result of the implementation model are different from each other, the scenario-model reference-graph generating unit 23 parses the scenario model stored in the scenario-model storage unit 11 to generate a CDFG. For example, the scenario-model reference-graph generating unit 23 parses the scenario model exemplarily depicted in FIG. 4 to generate a CDFG exemplarily depicted in FIG. 7.

The CDFG is a directed graph generated by adding information about a flow of control to a basic block forming a program. There are various types of data structure representing a basic block. In the first embodiment, it is assumed that a basic block forming a scenario model is represented by using a data structure exemplarily depicted in FIG. 8.

The data structure exemplarily depicted in FIG. 8 is now explained. The data structure of the CDFG in the first embodiment includes a function data structure, a variable-table data structure, and a basic-block data structure. As exemplarily depicted in FIG. 8, the function data structure is formed of a function name, a pointer to a variable table data structure, and a pointer to a basic-block data structure. Also as exemplarily depicted in FIG. 8, the variable-table data structure is formed of a list of records each formed of a variable name, an input/output type, and a variable type. Furthermore, as exemplarily depicted in FIG. 8, the basic-block data structure is formed of a block type, an equation included in the block, and a pointer to a block to be processed next.

The scenario-model reference-graph generating unit 23 in the first embodiment parses the scenario model stored in the scenario-model storage unit 11 for representation by using the data structure exemplarily depicted in FIG. 8, thereby generating a CDFG exemplarily depicted in FIG. 9. For example, the scenario-model reference-graph generating unit 23 extracts “if(a<0) a=0” as a basic block from the scenario model stored in the scenario-model storage unit 11. Next, the scenario-model reference-graph generating unit 23 determines whether the extracted basic block is a block without a branch, a branching block, or a block with no next block. Then, when determining that the block is a branching block, the scenario-model reference-graph generating unit 23 sets the block type in the data structure as “branch”. Since the type is “branch”, the scenario-model reference-graph generating unit 23 then sets the equation in the data structure as “a<0”. Since the type if “branch”, the scenario-model reference-graph generating unit 23 sets a pointer to be followed when the conditional expression is “true” and a pointer to be followed when the conditional expression is “false” toward respective relevant basic blocks. The scenario-model reference-graph generating unit 23 then repeats a procedure similar to the above to generate the CDFG exemplarily depicted in FIG. 9 from the scenario model.

That is, the CDFG exemplarily depicted in FIG. 7 represents the same contents as those in the CDFG exemplarily depicted in FIG. 9, and is represented as a simple flowchart of the CDFG exemplarily depicted in FIG. 9. Here, generation of the CDFG is achieved by a general compiler's function (refer to “Compiler II-principles, techniques, and tools-” written by Kenichi Harada, first edition, Saiensu-sha Co., Ltd., November 10, 1990, pp. 646-648, pp. 718-721).

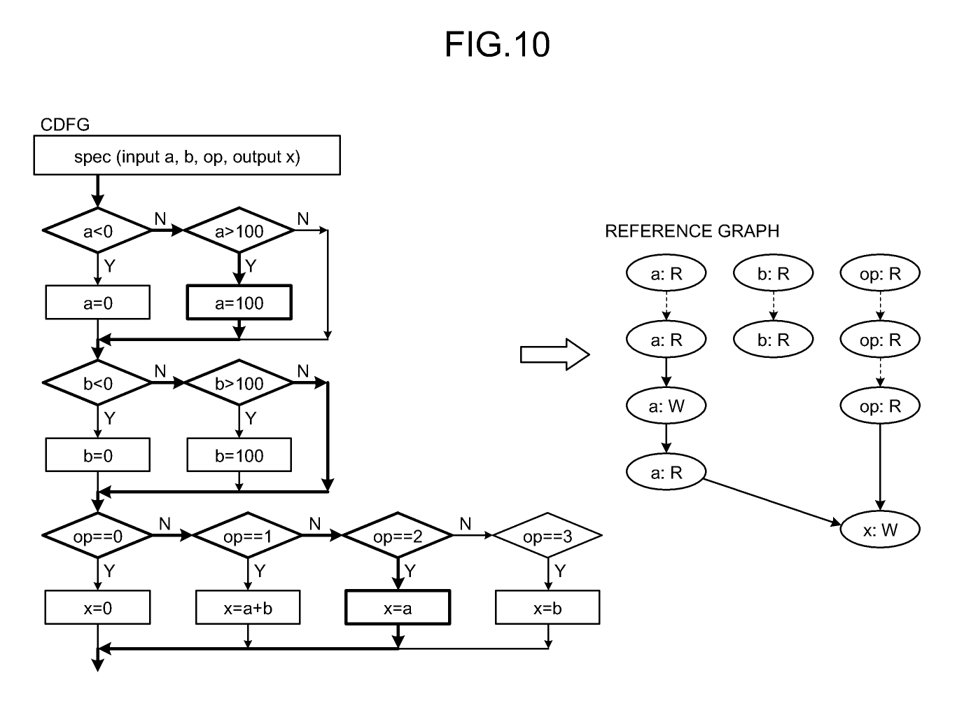

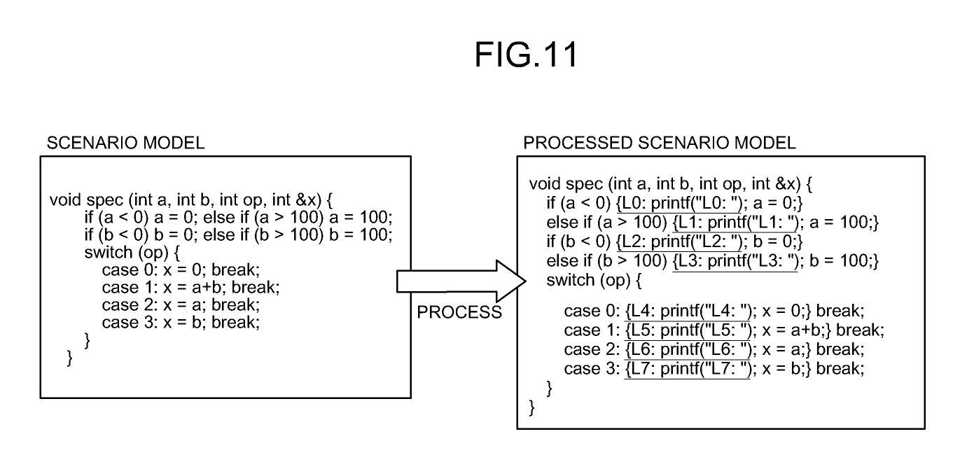

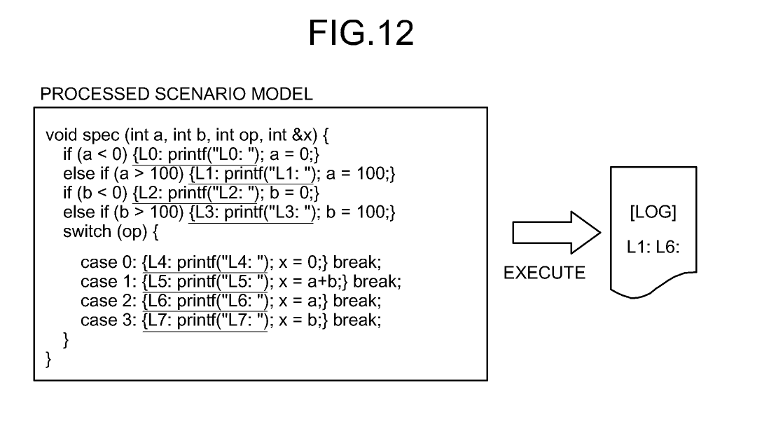

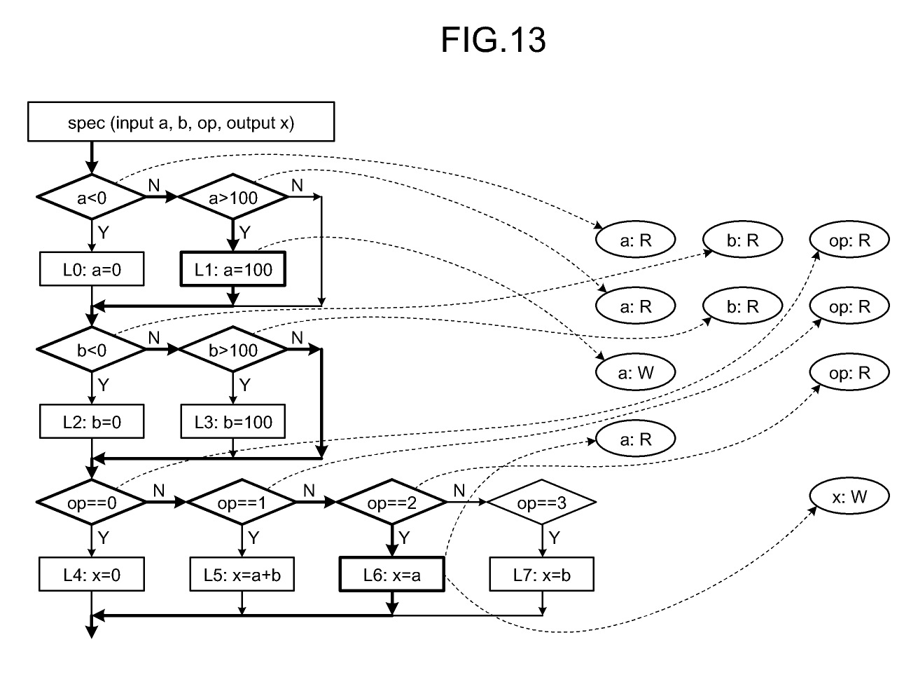

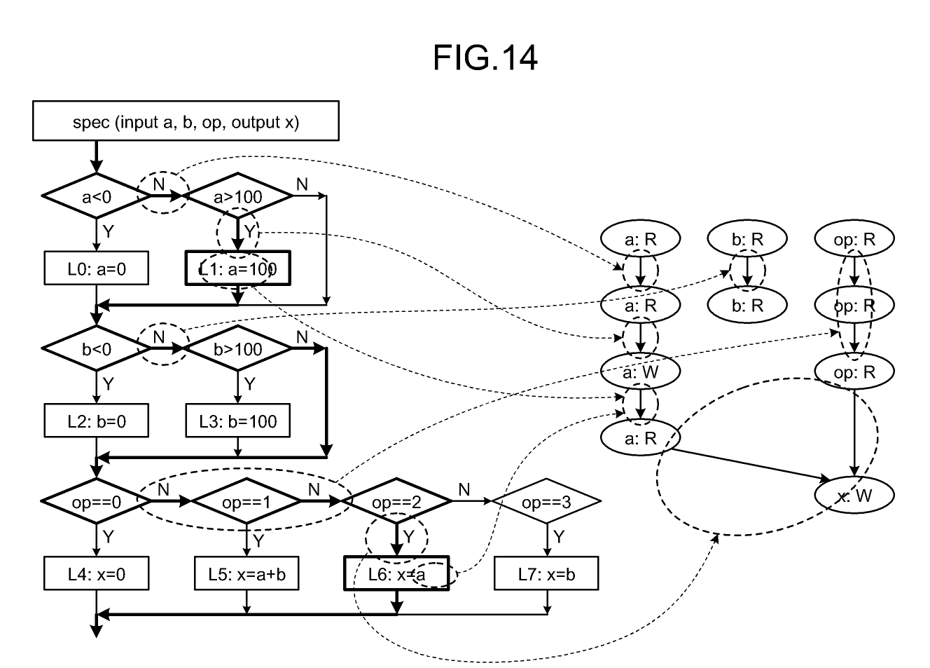

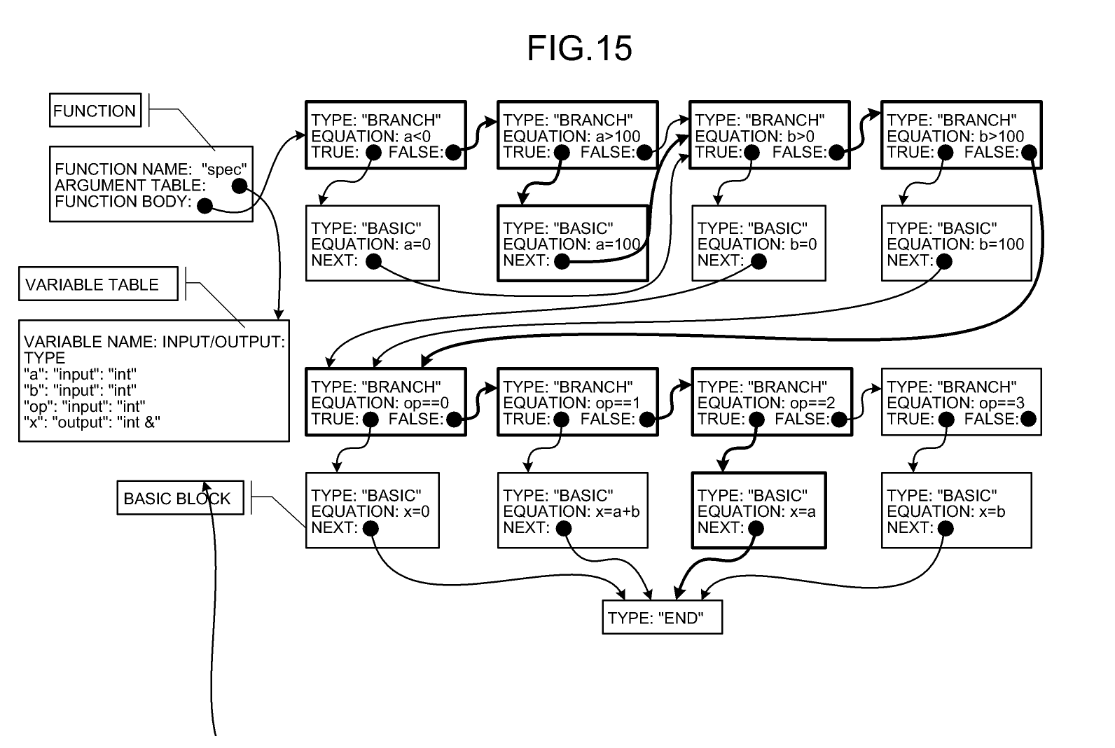

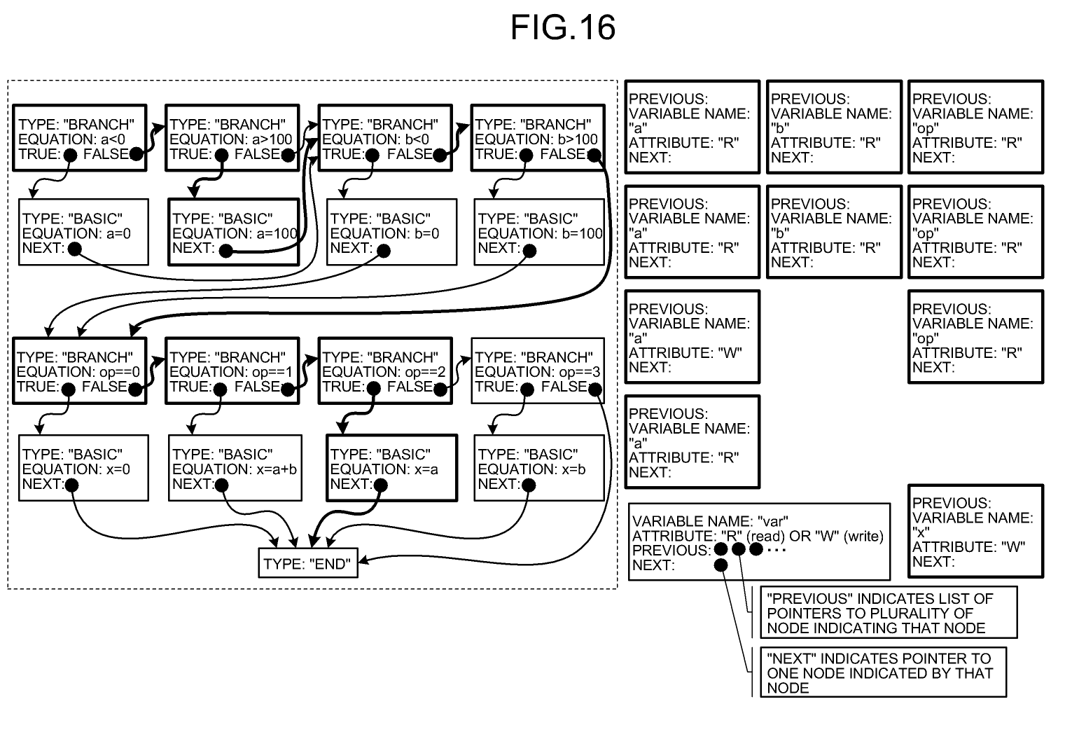

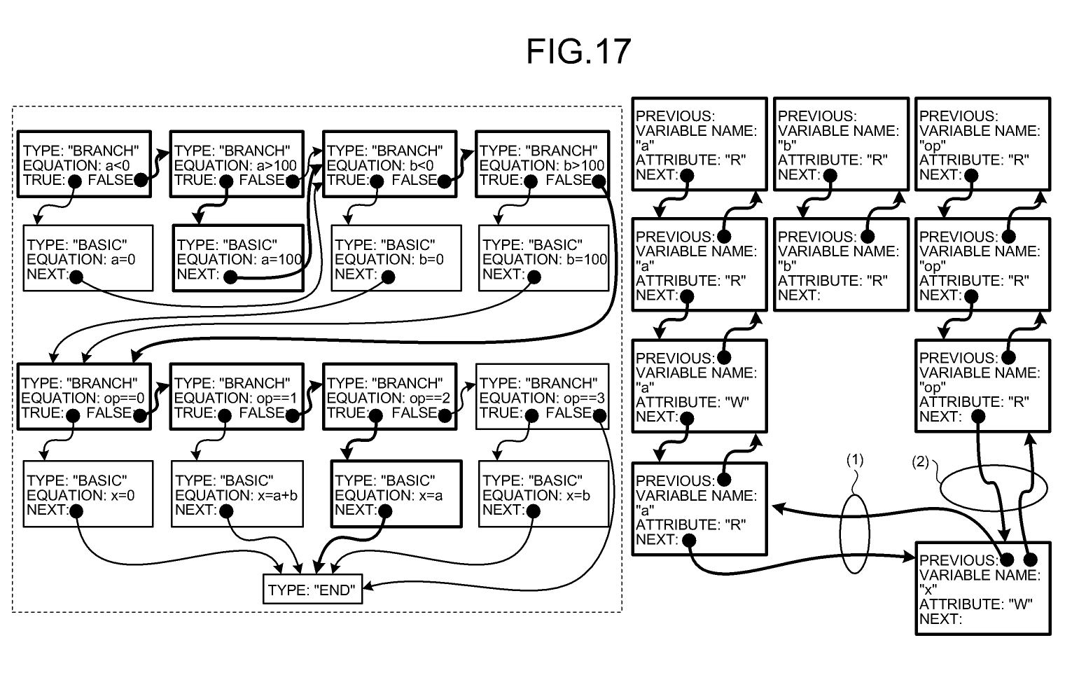

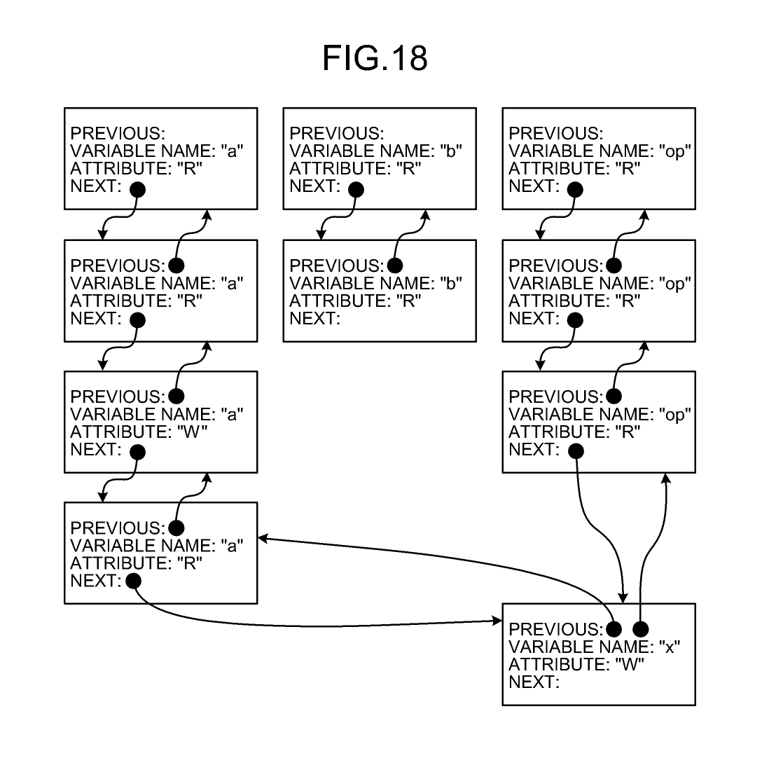

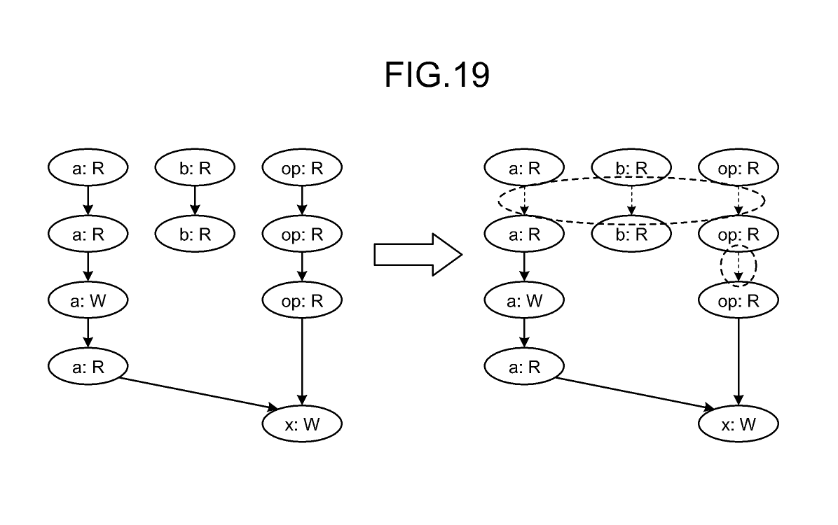

Next, generation of a reference graph from the CDFG is explained by using FIGS. 10 to 19. FIG. 10 is a drawing for explaining generation of a reference graph of the scenario model. FIG. 11 is a drawing for explaining processing of the scenario model. FIG. 12 is a drawing for explaining collection of execution path information. FIG. 13 is a drawing for explaining node extraction for the reference graph. FIG. 14 is a drawing for explaining edge extraction for the reference graph. FIG. 15 is a drawing for explaining extraction of an execution trace. FIG. 16 is a drawing for explaining node extraction in the reference graph. FIG. 17 is a drawing for explaining edge extraction in the reference graph. FIG. 18 is a drawing for explaining the reference graph. FIG. 19 is a drawing for explaining dependency.

The scenario-model reference-graph generating unit 23 uses a log transmitted from the scenario-model executing unit 21 to generate a reference graph from the CDFG. For example, as exemplarily depicted in FIG. 10, the scenario-model reference-graph generating unit 23 generates a reference graph from the CDFG.

First, as explained above, in the first embodiment, the scenario-model executing unit 21 processes the scenario model stored in the scenario-model storage unit 11 to execute the processes scenario model, thereby collecting the execution path information when executing the scenario model. For example, as depicted in FIG. 11, for the scenario model, the scenario-model executing unit 21 recognizes a basic block through parsing, and then embeds a labeled print statement in each basic block for outputting that the basic block has been executed (refer to underlined portions). Then, as depicted in FIG. 12, the scenario-model executing unit 21 assigns the test pattern to the input variable of the scenario model with the labeled print statement embedded therein to execute the scenario model, and collects execution path information (“L1:L6:”) indicative of the executed basic blocks. Subsequently, the scenario-model executing unit 21 transmits the collected execution path information to the scenario-model reference-graph generating unit 23. Although the technique of processing the scenario model by the scenario-model executing unit 21 to collect execution path information has been explained in the first embodiment, a technique of using trace information output from a debugger may be taken.

On the other hand, the scenario-model reference-graph generating unit 23 uses the CDFG generated by parsing the scenario model and the execution path information transmitted from the scenario-model executing unit 21 to extracts an execution trace from the CDFG, as depicted in FIG. 13. Then, as depicted in FIG. 13, the scenario-model reference-graph generating unit 23 extracts a read process (R) and a write process (W) for the input variable on the extracted execution trace, and takes these extracted processes as nodes for the reference graph. Then, as depicted in FIG. 14, the scenario-model reference-graph generating unit 23 extracts a dependency between nodes in the reference graph, and takes this as an edge for the reference graph.

An explanation is further made by using the data structure of the CDFG. The scenario-model reference-graph generating unit 23 uses the CDFG generated by parsing the scenario model and the execution path information transmitted from the scenario-model executing unit 21 to extracts an execution trace from the CDFG, as depicted in FIG. 15 (refer to bold frames and bold lines). In FIG. 5, although a technique of marking those executed from among nodes in the CDFG has been explained, a technique may be taken in which, for example, a flag for marking is provided to the data structure of a basic block and the flag is set. Alternatively, another technique may be taken in which a list is separately provided for registering the executed node.

Then, as depicted in FIG. 16, for an input variable on the extracted execution trace, the scenario-model reference-graph generating unit 23 extracts a read process (R) and a write process (W) and takes these processes as nodes for the reference graph. That is, for the marked nodes, the scenario-model reference-graph generating unit 23 determines that an input variable whose value has been read in “equation” in the data structure indicates a read process and, on the other hand, determines that an input variable to which a value is assigned indicates a write process. The scenario-model reference-graph generating unit 23 then extracts a node for the reference graph for each input variable, provided “attribute” to the data structure, and then sets a read process and a write process.

Subsequently, the scenario-model reference-graph generating unit 23 extracts a reference dependency between nodes for the reference graph from the execution trace of the CDFG and, as depicted in FIG. 17, adds a pointer between the nodes for the reference graph. First, the scenario-model reference-graph generating unit 23 adds a pointer between nodes in the reference graph so that the read process and the write process from and to the same input variable keeps the order on the execution trace. Also, when the “equation” is an assignment expression and the right side represents a read process and the left side represents a write process, the scenario-model reference-graph generating unit 23 adds a pointer between a node to be read and a node in which data is written (refer to (1) in FIG. 17).

Furthermore, in “equation” in the data structure, the scenario-model reference-graph generating unit 23 adds a pointer between a node corresponding to an input-variable read process and a node corresponding to an input-variable write process at its branch destination (refer to (2) in FIG. 17). The branch destination is a node residing on a course where a flow branched from the branching node converges again. For example, a node “a=100” is a branch destination of a node “a<0”, and a node “x=a” is a branch destination of a node “op==2”. In this manner, the scenario-model reference-graph generating unit 23 generates a reference graph, as depicted in FIG. 18.

Still further, when there are successive read processes (R), the scenario-model reference-graph generating unit 23 reads the same value, and therefore no dependency is assumed and a broken arrow (an attribute is provided to an arrow object) is used to represent an edge of the reference graph.

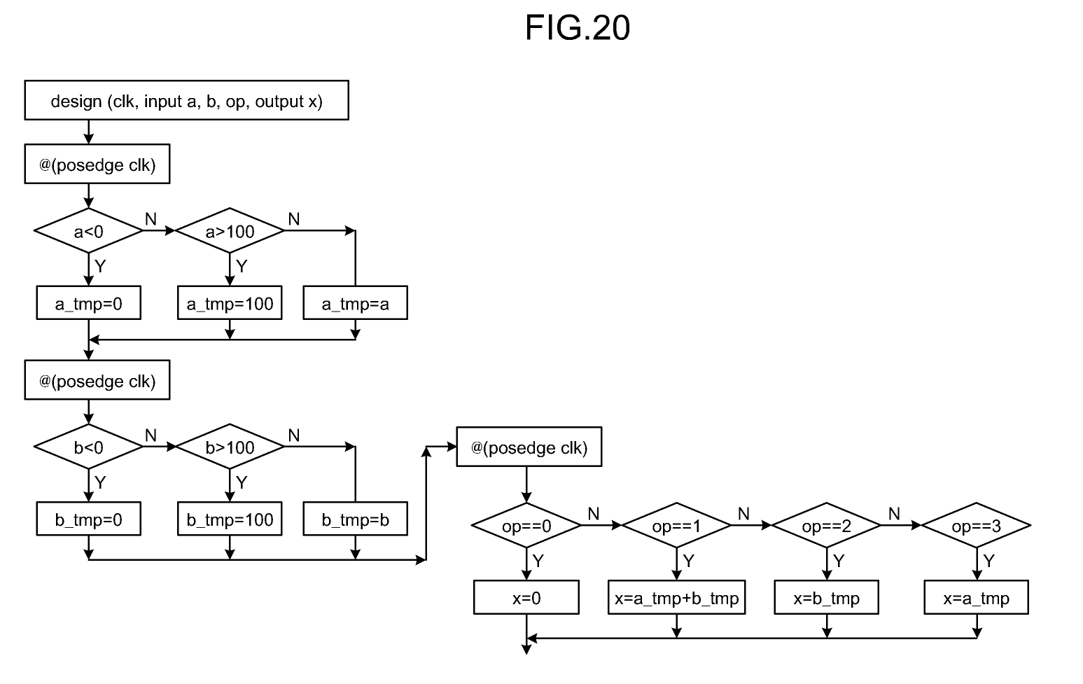

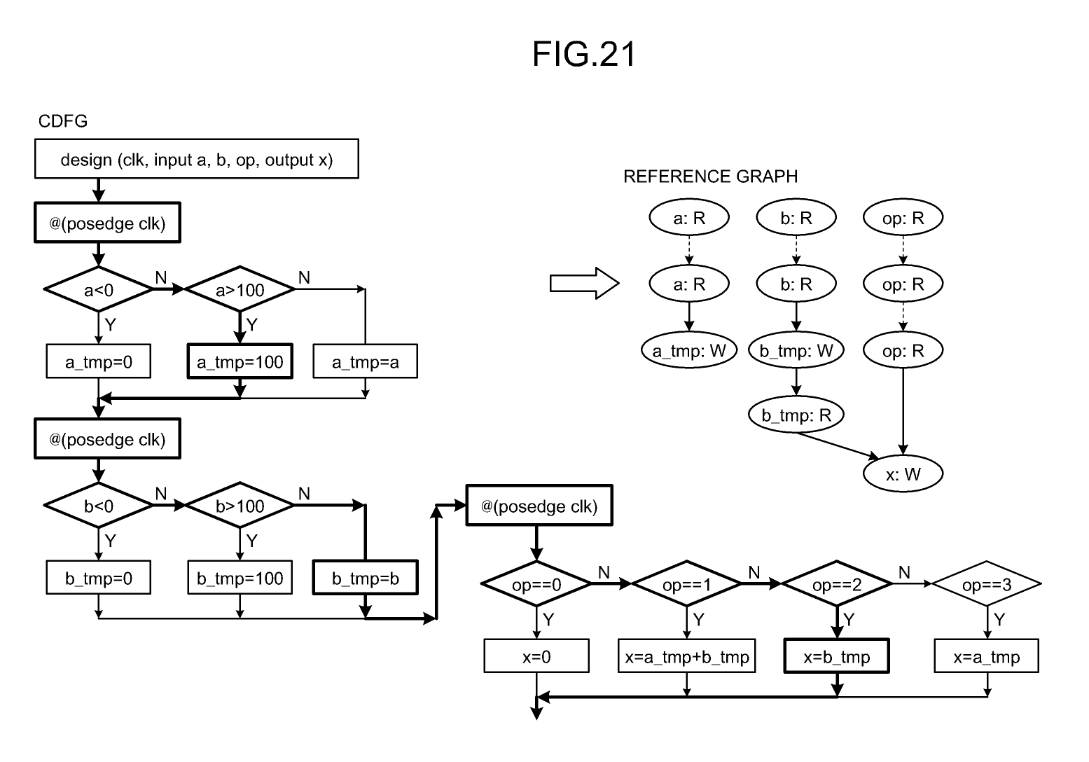

The implementation model is briefly explained by using FIGS. 20 and 21. FIG. 20 is a drawing for explaining a CDFG of the implementation model. FIG. 21 is a drawing for explaining generation of a reference graph of the implementation model. As with the scenario-model reference-graph generating unit 23, the implementation-model reference-graph generating unit 24 parses the implementation model exemplarily depicted in FIG. 5 to generate a CDFG exemplarily depicted in FIG. 20. Next, as with the scenario-model reference-graph generating unit 23, the implementation-model reference-graph generating unit 24 uses execution path information transmitted from the implementation-model executing unit 22 to generate a reference graph from the CDFG, as exemplarily depicted in FIG. 21.

The execution-result comparing unit 25 compares the execution result output upon execution of the scenario model (the value of the output variable) and the execution result output upon execution of the implementation model with each other. Specifically, the execution-result comparing unit 25 compares the execution result stored in the scenario-model execution-result storage unit 14 and the execution result stored in the implementation-model execution-result storage unit 15 with each other. Then, when these two values are different from each other as a result of comparison, the execution-result comparing unit 25 transmits the comparison result indicating that these values are different from each other to the scenario-model reference-graph generating unit 23 and the implementation-model reference-graph generating unit 24.

The reference-graph analyzing and detecting unit 26 compares the reference graph of the scenario model and the reference graph of the implementation model with each other to detect a difference between the scenario model and the implementation model. Specifically, the reference-graph analyzing and detecting unit 26 compares the reference graph stored in the scenario-model reference-graph storage unit 16 and the reference graph stored in the implementation-model reference-graph storage unit 17 with each other to detect a difference, and then stores the detection result in the detection-result storage unit 18.

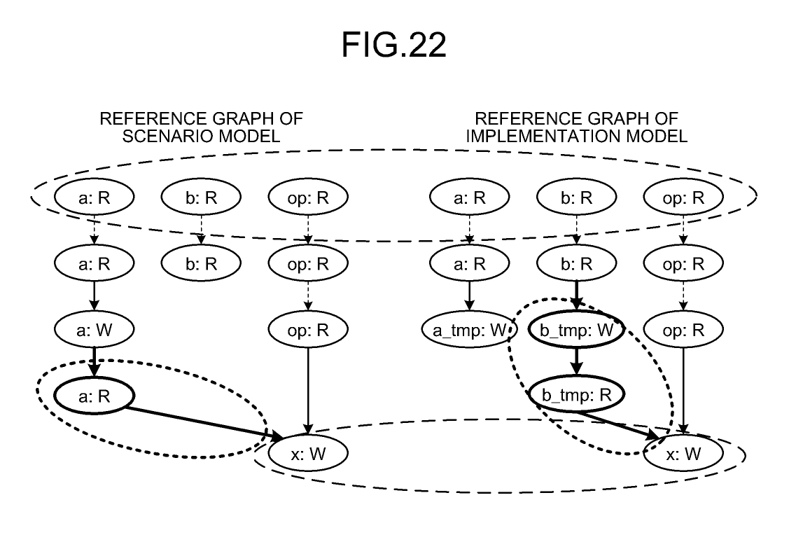

For example, as depicted in FIG. 22, the reference-graph analyzing and detecting unit 26 parses each of the paths of the corresponding input variables (name matching, specification by the user, etc.) between the scenario model and the implementation model to detect a difference between these models in the structure of the read process and the write process. FIG. 22 is a drawing for explaining analysis of the reference graph.

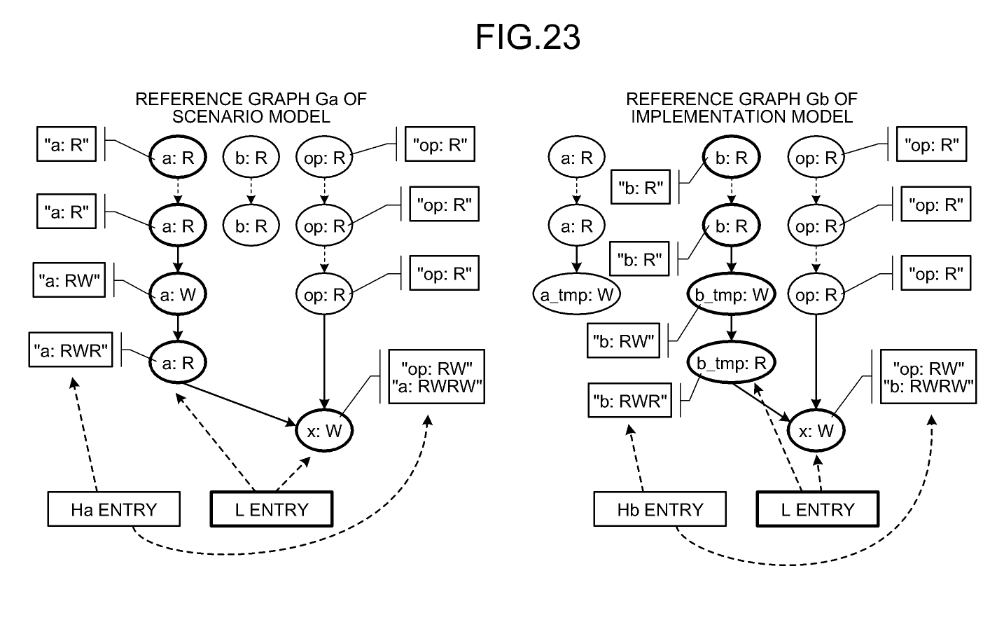

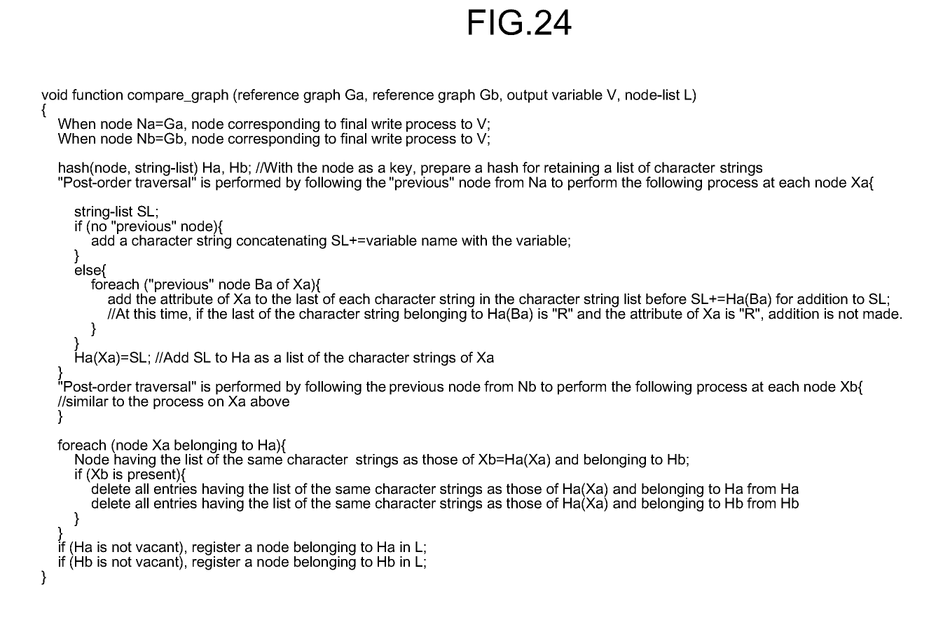

An explanation is further made by using FIGS. 23 and 24. FIG. 23 is a drawing for explaining analysis of the reference graph. FIG. 24 is a drawing for explaining a comparison algorithm for the reference graph.

The program depicted in FIG. 24 is a program for comparing a reference graph Ga of the scenario model and a reference graph Gb of the implementation model. As depicted in FIG. 24, a node Na is a node corresponding to the final write process to an output variable V in the reference graph Ga, whilst a node Nb is a node corresponding to the final write process to an output variable V in the reference graph Gb.

The reference-graph analyzing and detecting unit 26 first performs a post-order traversal search from the node Na (the node corresponding to the final write process to the output variable) in the reference graph Ga. Here, at each node, if there is no previous node, a character string with an input variable name and an attribute concatenated together with “:” is added to a character string list and, if there is a previous node, the attribute of the node is added to each character string in the character string list. At this time, when the attribute of the final node in the character string is “R” and the attribute of the node to be added is “R”, no addition is made. With this, a relation is achieved such that no dependency is assumed in the case of successive read processes (R). The reference-graph analyzing and detecting unit 26 then adds the generated character string list to an entry Ha. Also in the reference graph Gb, the reference-graph analyzing and detecting unit 26 performs a post-order traversal search from the node Nb to follow the previous node, and adds the generated character string list to an entry Hb.

The reference-graph analyzing and detecting unit 26 then compares the character string list group Ha generated for the reference graph Ga and the character string list group Hb generated for the reference graph Gb with each other and, deletes the same character string list from each entry. Then, if the character string list group Ha is not empty, the nodes belonging to Ha are registered in a node list L. If the character string list group Hb is not empty, the nodes belonging to Hb are registered in the node list L.

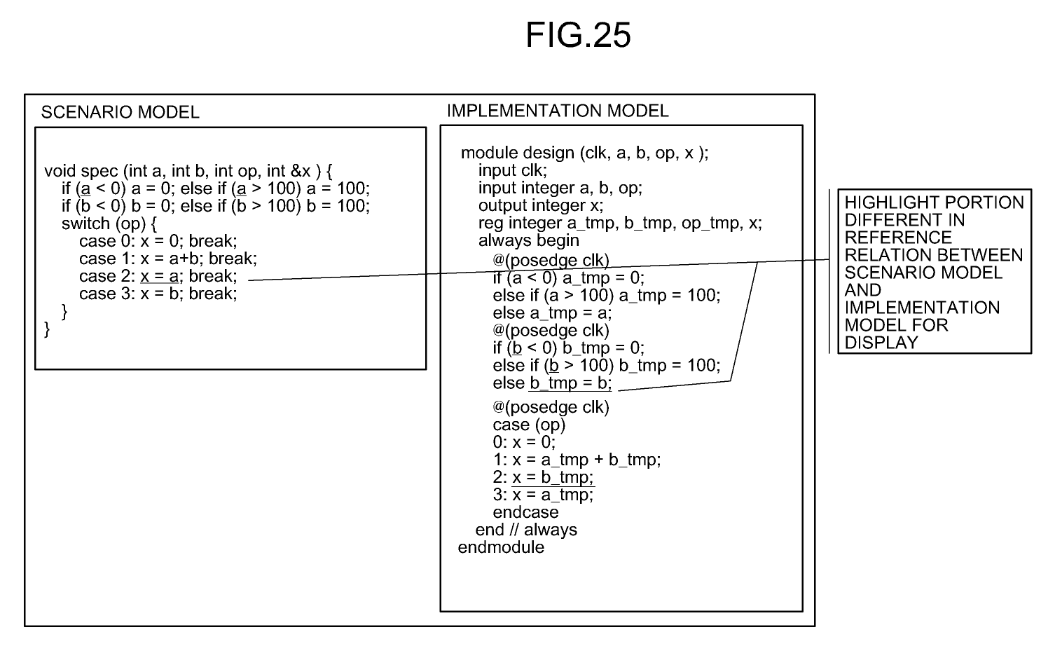

The reference-graph analyzing and detecting unit 26 in the first embodiment outputs the detection result to the output unit (not illustrated), such as a display. For example, the reference-graph analyzing and detecting unit 26 determines a corresponding row in the descriptions of the scenario model and the implementation model via the CDFG from a point where the reference graph of the scenario model and the reference graph of the implementation model are different from each other (node list L). Then, as exemplarily depicted in FIG. 25, the reference-graph analyzing and detecting unit 26 outputs the descriptions of the scenario model and the implementation model to the output unit so that the row determined as the corresponding row (equation including the input variable) is highlighted. Alternatively, a sentence or voice, such as “there is a dependency in the scenario model from a read process with an input variable a to a write process with an output variable x, whilst there is a dependency in the implementation model from a read process with b_tmp to a write process with the output variable x” may be output. FIG. 25 is a drawing for explaining an output screen of the detection result.

### Process Procedure by the Detecting Device According to the First Embodiment

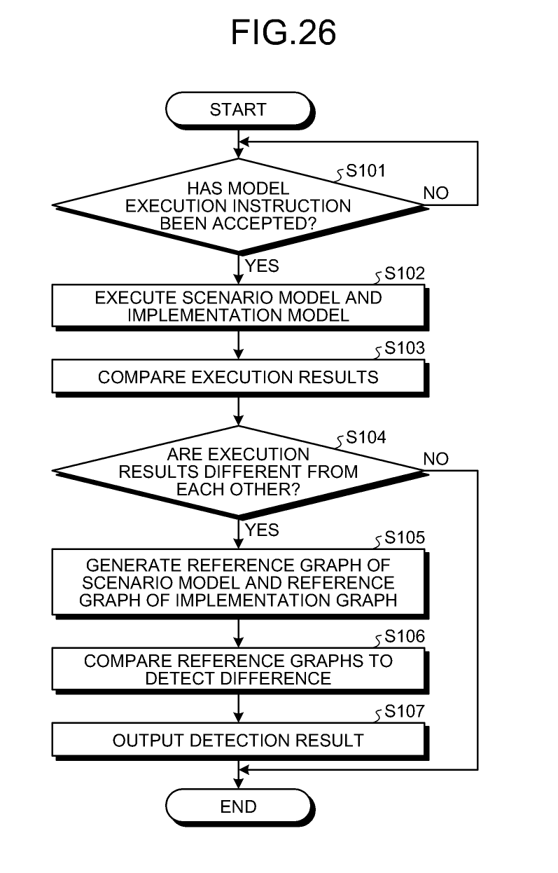

The process procedure by the detecting device according to the first embodiment is explained by using FIG. 26. FIG. 26 is a flowchart of a process procedure by the detecting device according to the first embodiment.

As depicted in FIG. 26, the detecting device 10 according to the first embodiment determines whether model-execution instruction indicating to execute the scenario model and the implementation model has been accepted (step S101). If a model execution instruction has been accepted (“Yes” at step S101), the detecting device 10 executes the scenario model and the implementation model at the scenario-model executing unit 21 and the implementation-model executing unit 22 (step S102).

The detecting device 10 then compares the execution result of the scenario model and the execution result of the implementation model with each other (step S103) to determine whether the execution results are different from each other (step S104). Specifically, the execution-result comparing unit 25 of the detecting device 10 compares the execution result stored in the scenario-model execution-result storage unit 14 and the execution result stored in the implementation-model execution-result storage unit 15 with each other. When the execution results are the same (“No” at step S104), the detecting device 10 ends the process.

On the other hand, when the execution results are different from each other (“Yes” at step S104), the detecting device 10 generates a reference graph of the scenario model and a reference graph of the implementation model (step S105). Specifically, when the execution results are different from each other, from the execution-result comparing unit 25 to the scenario-model reference-graph generating unit 23 and the implementation-model reference-graph generating unit 24, information is transmitted indicating that it is determined as a result of comparison that the execution results are different from each other. Then, the scenario-model reference-graph generating unit 23 and the implementation-model reference-graph generating unit 24 of the detecting device 10 generate a reference graph of the scenario model and a reference graph of the implementation model, respectively.

The detecting device 10 then compares the generated reference graphs with each other to detect a difference (step S106). Specifically, the reference-graph analyzing and detecting unit 26 of the detecting device 10 compares the reference graph stored in the scenario-model reference-graph storage unit 16 and the reference graph stored in the implementation-model reference-graph storage unit 17 with each other to detect a difference.

The detecting device 10 then outputs the detection result (step S107), and then ends the process. Specifically, the reference-graph analyzing and detecting unit 26 of the detecting device 10 outputs the detection result to the output unit, and ends the process.

### Effect of the First Embodiment

As has been explained above, according to the first embodiment, the detecting device assigns the test pattern to the input variable of the scenario model to execute the scenario model. Also, the detecting device assigns the test pattern to the input variable of the implementation model to execute the implementation model. Furthermore, for each input variable of the scenario model, the detecting device analyzes the structure of the read process and the write process performed from the time when the test value is assigned to the input variable to the time when the resultant value is assigned to the output variable to generate a reference graph. Still further, for each input variable of the implementation model, the detecting device analyzes the structure of the read process and the write process performed from the time when the test value is assigned to the input variable to the time when the resultant value is assigned to the output variable to generate a reference graph. Still further, the detecting device compares the execution result of the scenario model and the execution result of the implementation model with each other, and compares the reference graphs of these models when the execution results are different from each other to detect a difference between the scenario model and the implementation model. From this, according to the first embodiment, a fault in the implementation model can be efficiently and appropriately detected.

That is, in the conventional technique of performing a simulation, the developer has to manually trace main signals, and therefore a fault in the implementation model cannot be efficiently detected. On the other hand, according to the first embodiment, the detecting device detects a difference between the scenario model and the implementation model. Therefore, all what is required for the developer is to study the difference detected by the detecting device. Thus, a fault in the implementation model can be efficiently detected.

Also, in the conventional technique of comparing the signal databases, the signal databases generated from the descriptions of the scenario model and the implementation model are merely compared with each other, and therefore a fault in the implementation model cannot be appropriately detected. On the other hand, according to the first embodiment, the detecting device assigns the test pattern to the scenario model and the implementation model, and compares the reference graphs dynamically generated based on the dynamic execution paths when the test pattern is executed. Therefore, a fault in the implementation model can be accurately detected.

Furthermore, according to the first embodiment, the detecting device highlights the detected difference or outputs a sentence or voice indicative of the detected difference. Therefore, the developer can more efficiently understand a fault in the implementation model. In the first embodiment, the detecting device causes the implementation model described in Verilog to be displayed on a screen to highlight a row corresponding to the difference. If, for example, the implementation model can be edited on the same screen, the developer can also correct a fault in the implementation model on the spot, thereby allowing a more efficient developing operation.

### Second Embodiment

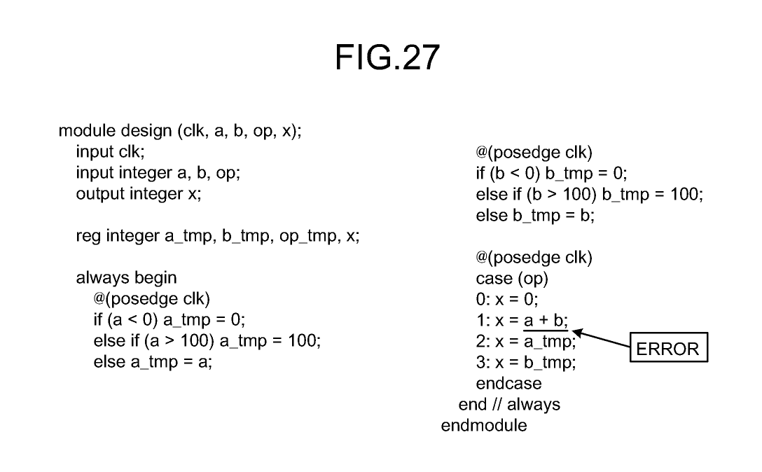

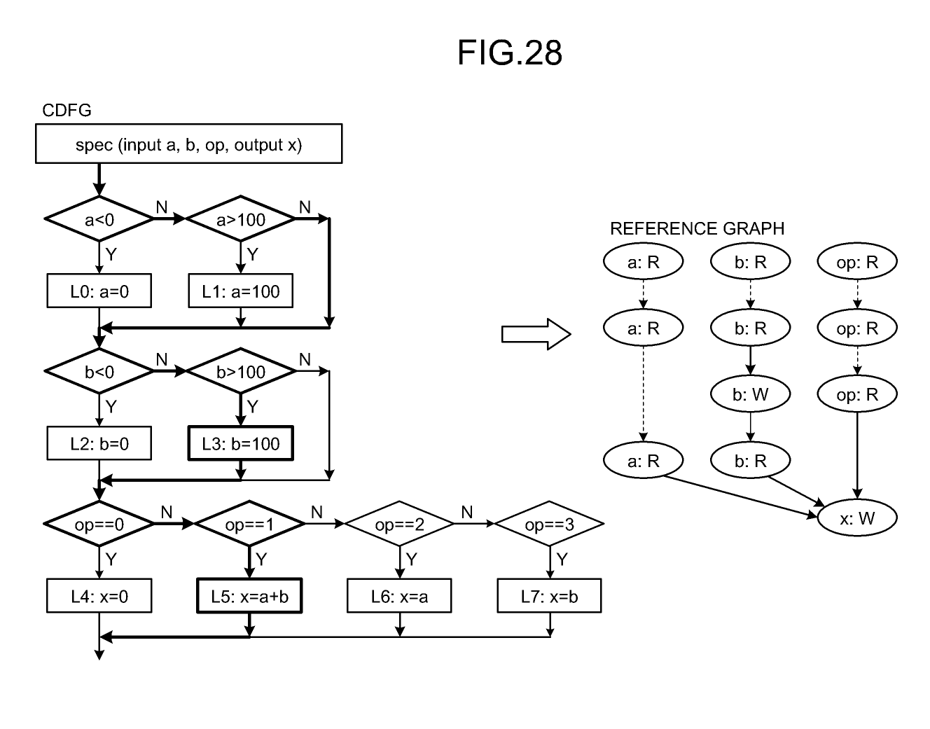

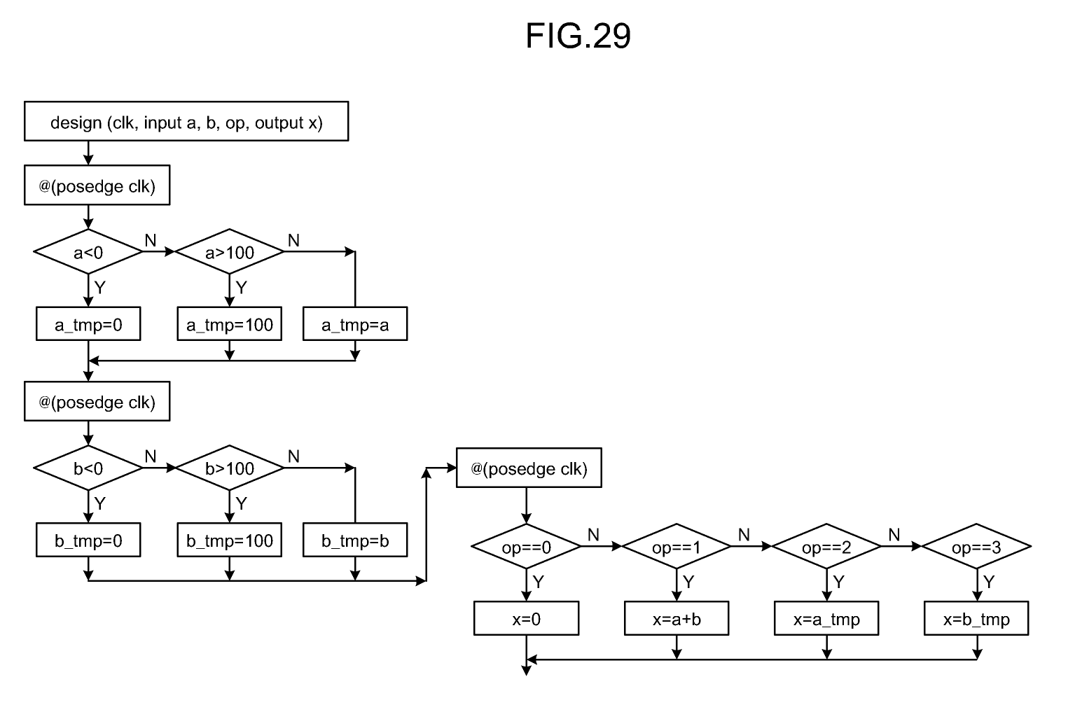

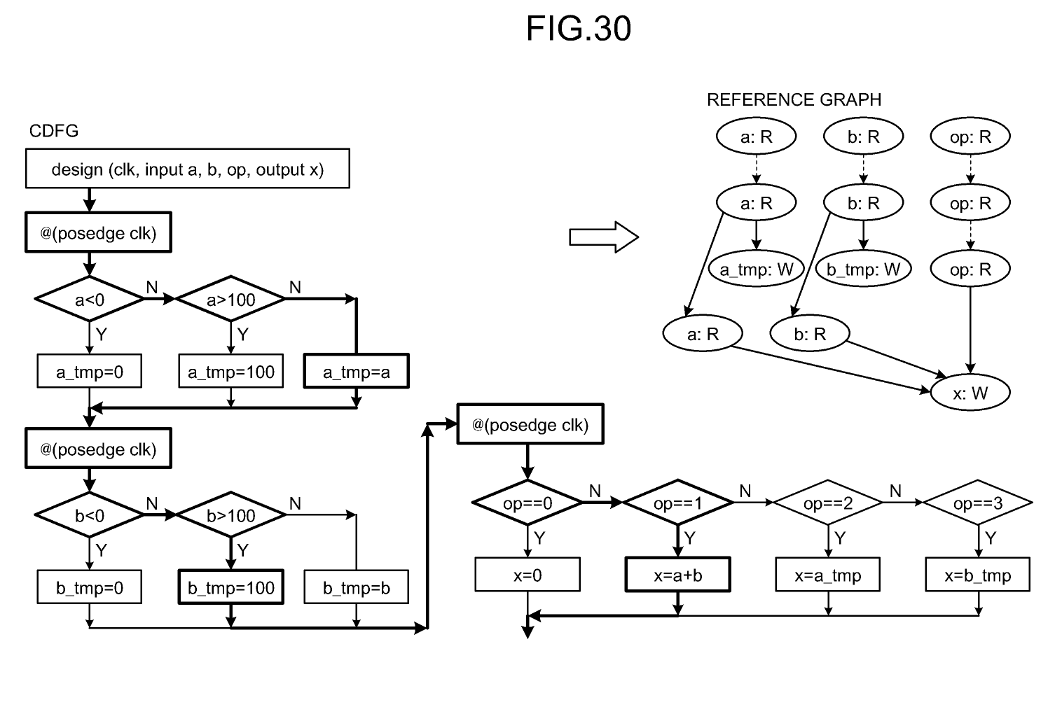

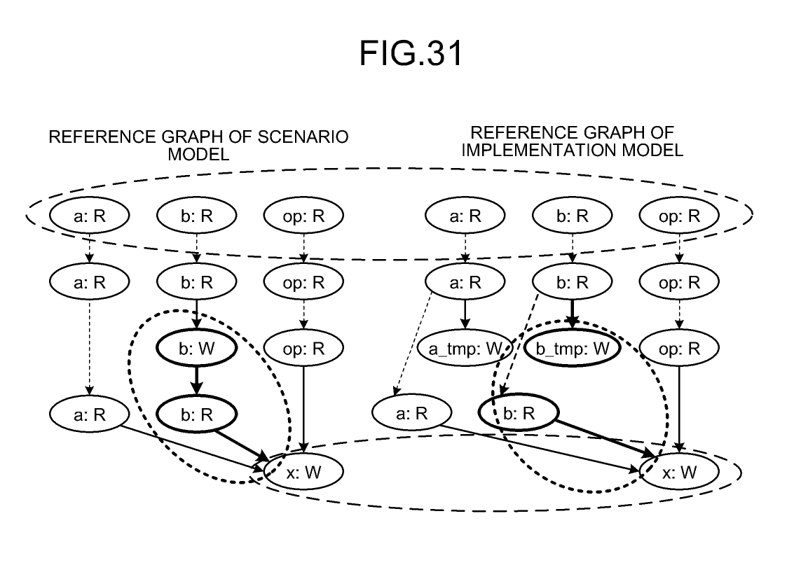

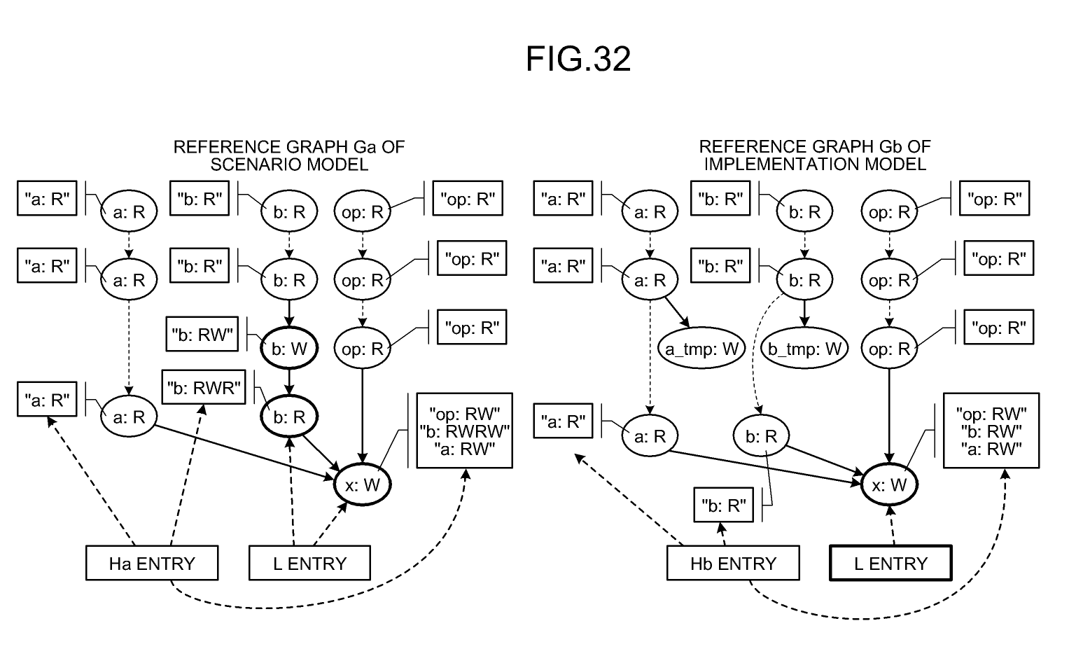

In a second embodiment, a case is explained by using FIGS. 27 to 33 where the implementation-model storage unit 12 has stored therein an implementation model different from that in the first embodiment. FIG. 27 is a drawing for explaining an implementation model. FIG. 28 is a drawing for explaining generation of a reference graph of the scenario model. FIG. 29 is a drawing for explaining a CDFG of the implementation model. FIG. 30 is a drawing for explaining generation of a reference graph of the implementation model. FIGS. 31 and 32 are drawings for explaining analysis of the reference graph.

First, the implementation-model storage unit 12 in the second embodiment has stored therein an implementation model exemplarily depicted in FIG. 27. As exemplarily depicted in FIG. 27, as with the first embodiment, the implementation model in the second embodiment has the scenario 1 exemplarily depicted in FIG. 3 described in Verilog, though a fault different from that in the first embodiment is included, as exemplarily depicted in FIG. 27.

The scenario-model executing unit 21 and the implementation-model executing unit 22 in the second embodiment execute two test patterns. For example, the scenario-model executing unit 21 in the second embodiment assigns the test pattern (110, 10, 2) to input variables of the scenario model (a, b, op) to execute the scenario model, and then stores the execution result “x=100” in the scenario-model execution-result storage unit 14. Then, the scenario-model executing unit 21 in the second embodiment assigns the test pattern (10, 110, 1) to input variables of the scenario model (a, b, op) to execute the scenario model, and then stores the execution result “x=100”.

Also, the implementation-model executing unit 22 in the second embodiment first assigns the test pattern (110, 10, 2) to input variables of the implementation model (a, b, op) to execute the implementation model, and then stores the execution result “x=100” in the implementation-model execution-result storage unit 15. Subsequently, the implementation-model executing unit 22 assigns the test pattern (10, 110, 1) to input variables of the implementation model (a, b, op) to execute the implementation model, and then stores the execution result “x=120”.

The execution-result comparing unit 25 in the second embodiment compares the execution results with each other when the test pattern (110, 10, 2) is assigned for execution to obtain a comparison result that these two values are not different from each other. Also, the execution-result comparing unit 25 compares the execution results with each other when the test pattern (10, 110, 1) is assigned for execution to obtain a comparison result that these two values are different from each other. Therefore, for the test pattern (10, 110, 1), the execution-result comparing unit 25 transmits the comparison result indicating that these values are different from each other to the scenario-model reference-graph generating unit 23 and the implementation-model reference-graph generating unit 24.

Then, as depicted in FIG. 28, the scenario-model reference-graph generating unit 23 generates a reference graph of the scenario model for the test pattern (10, 110, 1). Also, as depicted in FIGS. 29 and 30, the implementation-model reference-graph generating unit 24 generates a reference graph of the implementation model for the test pattern (10, 110, 1).

Subsequently, as with the first embodiment, the reference-graph analyzing and detecting unit 26 compares the reference graph of the scenario model and the reference graph of the implementation model to detect a difference between the scenario model and the implementation model. For example, as depicted in FIGS. 31 and 32, the reference-graph analyzing and detecting unit 26 in the second embodiment analyzes each path of the input variable corresponding to the scenario model and the implementation model to detect a difference between these models in the structure of the read process and the write process.

### Other Embodiments

Meanwhile, the embodiments of the present invention have been explained, the present invention may be implemented in various different forms other than the embodiment explained above.

[Artificial Language]

In the embodiments explained above, it is assumed that the scenario model is described in the C language and the implementation model is described in Verilog. However, the present invention is not meant to be restricted to this. That is, the scenario model and the implementation model may be described in any artificial language allowed to be processed by a computer, and the artificial language is not restricted to the C language or Verilog.

[Process Procedure]

Also, in the embodiments explained above, the process procedure is explained such that the detecting device first compares the execution result of the scenario model and the execution result of the implementation model with each other and, when it is determined as a result of the comparison that the execution results are different from each other, a reference graph of the scenario model and a reference graph of the implementation model are generated. However, the present invention is not meant to be restricted to this. For example, the detecting device may generate reference graphs simultaneously when executing the scenario model and the implementation model. In this case, after it is determined that the execution results are different from each other, the detecting device compares the reference graphs generated in advance to analyze a difference.

[Software Implementation]

Furthermore, in the embodiments explained above, it is assumed that the detecting device detects a fault in the implementation model at the time of implementation of hardware. However, the present invention is not meant to be restricted to this. The present invention can be similarly applied to the case where a fault in the implementation model is detected at the time of implementation of software. In this case, for example, the detecting device executes a scenario model having a scenario of a work system described in the C language and an implementation model described in COBOL. Also, the detecting device parses the scenario model described in the C language to generate a CDFG, and then generates a reference graph from the CDFG. Furthermore, the detecting device pareses the implementation model described in COBOL to generate a CDFG, and then generates a reference graph from the CDFG. The detecting device then compares the execution results of the scenario model and the implementation model and, when it is determined as a result of the comparison that the execution results are different from each other, compares the reference graph of the scenario model and the reference graph of the implementation model with each other to detect a difference.

[System Configuration and Others]

Still further, among the processes explained in the embodiments, all or part of the processes explained as being automatically performed may be manually performed. For example, in the embodiments explained, when detecting a difference between the scenario model and the implementation model, the detecting device automatically outputs the detection result to the output unit. Alternatively, for example, the detecting device may output the detection result to the output unit upon accepting an input of an output instruction from the developer.

Alternatively, all or part of the processes explained as being manually performed may be automatically performed through a known method. For example, in the embodiment, it is assumed that the scenario model and the implementation model are described in advance by the developer. Alternatively, for example, the detecting device may accept an input of a scenario and automatically generate a scenario model and an implementation model from the input-accepted scenario through a known method.

In addition, the process procedure (such as FIG. 26), specific names (such as FIG. 2), and information including various data and parameters in the specification and drawings can be arbitrarily changed unless otherwise specified.

Still further, each component depicted is conceptual in function, and is not necessarily physically configured as depicted (such as FIG. 2). That is, the specific patterns of distribution and unification of the components are not meant to be restricted to those depicted in the drawings. All or part of the components can be functionally or physically distributed or unified in arbitrary units according to various loads and the state of use. For example, the scenario-model storage unit 11 and the implementation-model storage unit 12 may be unified, and the scenario-model execution-result storage unit 14 and the implementation-model execution-result storage unit 15 may be unified. Still further, all or arbitrary part of the process functions performed in each component can be achieved by a Central Processing Unit (CPU) and a program analyzed and executed on that CPU, or can be achieved as hardware with a wired logic.

[Computer that Executes the Detection Program]

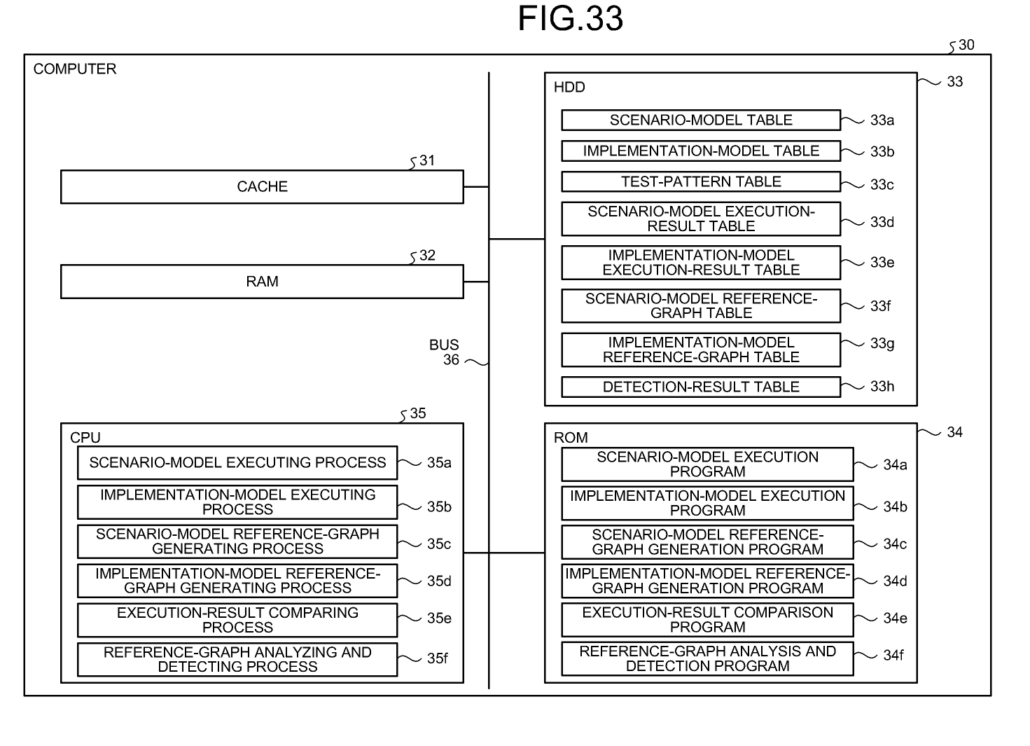

Still further, various processes explained in the embodiment can be achieved by a computer, such as a Personal Computer (PC) or a Work Station (WS), executing a program provided in advance. Thus, an example of a computer executing a detection program having functions similar to those in the embodiments explained is explained by using FIG. 33. FIG. 33 is a drawing of a computer that executes a detection program.

As depicted in FIG. 33, a detection program (computer) 30 includes a cache 31, a Random Access Memory (RAM) 32, a Hard Disk Drive (HDD) 33, a Read Only Memory (ROM) 34, and a CPU 35, which are connected via a bus 36. Here, the ROM 34 has incorporated therein a detection program achieving functions similar to those in the embodiments explained, that is, as depicted in FIG. 33, a scenario-model execution program 34a, an implementation-model execution program 34b, a scenario-model reference-graph generation program 34c, an implementation-model reference-graph generation program 34d, an execution-result comparison program 34e, and a reference-graph analysis and detection program 34f.

Then, the CPU 35 reads these programs 34a to 34f for execution. As a result, as depicted in FIG. 33, these programs 34a to 34f become a scenario-model executing process 35a, an implementation-model executing process 35b, a scenario-model reference-graph generation process 35c, an implementation-model reference-graph generating process 35d, an execution-result comparing process 35e, and a reference-graph analyzing and detecting process 35f. Here, these processes 35a to 35f correspond to the scenario-model executing unit 21, the implementation-model executing unit 22, the scenario-model reference-graph generating unit 23, the implementation-model reference-graph generating unit 24, the execution-result comparing unit 25, and the reference-graph analyzing and detecting unit 26 depicted in FIG. 2.

Also, as depicted in FIG. 33, the HDD 33 includes a scenario-model table 33a, an implementation-model table 33b, a test-pattern table 33c, a scenario-model execution-result table 33d, an implementation-model execution-result table 33e, a scenario-model reference-graph table 33f, an implementation-model reference-graph table 33g, and a detection-result table 33h. Here, these tables 33a to 33h correspond to the scenario-model storage unit 11, the implementation-model storage unit 12, the test-pattern storage unit 13, the scenario-model execution-result storage unit 14, the implementation-model execution-result storage unit 15, the scenario-model reference-graph storage unit 16, the implementation-model reference-graph storage unit 17, and the detection-result storage unit 18 depicted in FIG. 2.

Meanwhile, the programs 34a to 34f are not necessarily stored in the ROM 34 and, for example, may be stored in a “portable physical medium” such as a flexible disk (FD), a compact-disk read only memory (CD-ROM), a magneto-optical (MO) disk, a digital versatile disk (DVD), or an Integrated Circuit (IC) card, a “fixed physical medium” such as a hard disk drive (HDD) included inside or outside of the computer 30, or “another computer (or server)” connected to the computer 30 via a public line, the Internet, a Local Area Network (LAN), or a Wide Area Network (WAN), and then read by the computer 30 for execution.

According to the embodiments of the present invention, a fault in the implementation model can be efficiently and appropriately detected.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium that stores therein a detection program that causes a computer to execute:
when a scenario, in which the relation between a process performed according to an input variable and a value assigned to the input variable and an output variable to which a value of the result of the process is assigned is defined in a natural language, is described in a predetermined artificial language and is stored as a scenario model in a scenario-model storage unit, executing the scenario model by reading the scenario model from the scenario-model storage unit and assigning a predetermined test value to the input variable of the scenario model;
when the scenario is described in an artificial language for implementation and is stored as an implementation model in an implementation-model storage unit, executing the implementation model by reading the implementation model from the implementation-model storage unit and assigning the test value to the input variable of the implementation model;
analyzing a structure of a read process and a write process for each input variable of the scenario model by the executing of the scenario model, from a time when the test value is assigned to an input variable to a time when the resultant value is assigned to an output variable, to store the analyzed structure in a scenario-model analysis-result storage unit;
analyzing a structure of a read process and a write process for each input variable of the implementation model by the executing of the implementation model, from a time when the test value is assigned to an input variable to a time when the resultant value is assigned to an output variable, to store the analyzed structure in a implementation-model analysis-result storage unit;
comparing a value of the output variable output through the executing of the scenario model and a value of the output variable output through the executing of the implementation model; and
when the values of the output variables are different from each other as a result of the comparison, comparing the structure stored in the scenario-model analysis-result storage unit and the structure stored in the implementation-model analysis-result storage unit to detect a difference between the scenario model and the implementation model.

2. A detecting device comprising:
a scenario-model storage unit that stores a scenario model including a scenario, described in a predetermined artificial language, in which the relation between a process performed according to an input variable and a value assigned to the input variable and an output variable to which a value of the result of the process is assigned is defined in a natural language;
an implementation-model storage unit that stores an implementation model wherein the scenario is described in an artificial language for implementation;
a scenario-model executing unit that executes the scenario model by assigning a predetermined test value to the input variable of the scenario model stored in the scenario-model storage unit;
an implementation-model executing unit that executes the implementation model by assigning a predetermined test value to the input variable of the implementation model stored in the implementation-model storage unit;
a scenario-model analyzing unit that analyzes a structure of a read process and a write process for each input variable of the scenario model executed by the scenario-model executing unit, from a time when the test value is assigned to an input variable to a time when the resultant value is assigned to an output variable;
an implementation-model analyzing unit that analyzes a structure of a read process and a write process for each input variable of the implementation model executed by the implementation-model executing unit, from a time when the test value is assigned to an input variable to a time when the resultant value is assigned to an output variable;
a comparing unit that compares a value of the output variable output by executing the scenario-model executing unit and a value of the output variable output by executing the implementation-model executing unit; and
a detecting unit that compares, when the values of the output variables are different from each other as a result of the comparison by the comparing unit, the structure analyzed by the scenario-model analyzing unit and the structure analyzed by the implementation-model analyzing unit to detects a difference between the scenario model and the implementation model.

3. A detection method comprising:
when a scenario, in which the relation between a process performed according to an input variable and a value assigned to the input variable and an output variable to which a value of the result of the process is assigned is defined in a natural language, is described in a predetermined artificial language and is stored as a scenario model in a scenario-model storage unit, executing the scenario model by reading the scenario model from the scenario-model storage unit and assigning a predetermined test value to the input variable of the scenario model;
when the scenario is described in an artificial language for implementation and is stored as an implementation model in an implementation-model storage unit, executing the implementation model by reading the implementation model from the implementation-model storage unit and assigning the test value to the input variable of the implementation model;
analyzing a structure of a read process and a write process for each input variable of the scenario model by the executing of the scenario model, from a time when the test value is assigned to an input variable to a time when the resultant value is assigned to an output variable, to store the analyzed structure in a scenario-model analysis-result storage unit;
analyzing a structure of a read process and a write process for each input variable of the implementation model by the executing of the implementation model, from a time when the test value is assigned to an input variable to a time when the resultant value is assigned to an output variable, to store the analyzed structure in a implementation-model analysis-result storage unit;
comparing a value of the output variable output through the executing of the scenario model and a value of the output variable output through the executing of the implementation model; and
when the values of the output variables are different from each other as a result of the comparison, comparing the structure stored in the scenario-model analysis-result storage unit and the structure stored in the implementation-model analysis-result storage unit to detect a difference between the scenario model and the implementation model.
